(19) United States
(12) Patent Application Publication
(10) Pub. No.: US 2010/0179856 A1
(43) Pub. Date: Jul. 15, 2010

(54) CONDITIONAL INCENTIVE PRESENTATION, TRACKING AND REDEMPTION

(75) Inventors: Christopher T. Paretti, San Francisco, CA (US); Athellina Athsani, San Jose, CA (US); Marc E. Davis, San Francisco, CA (US); Joseph O'Sullivan, Oakland, CA (US); Christopher W. Higgins, Portland, OR (US); Ronald G. Martinez, San Francisco, CA (US)

Correspondence Address: FIALA & WEAVER, P.L.L.C.;C/O CPA GLOBAL, P.O. BOX 52050, MINNEAPOLIS, MN, 55402, US

(73) Assignee: YAHOO! INC., Sunnyvale, CA (US)

(21) Appl. No.: 12/353,795

(22) Filed: Jan. 14, 2009

(51) Int. Cl. G06Q 30/00; G06Q 10/00

(52) U.S. Cl. 705/10; 705/14.1; 705/14.25

(57) ABSTRACT

An offer is presented to a user via a user device, wherein the terms of the offer include at least one activity to be performed by the user or at least one behavior to be observed by the user and at least one incentive to be rewarded to the user responsive to the performance of the at least one activity or the observance of the at least one behavior. A determination is made as to whether the user has performed the at least one activity or observed the at least one behavior based on at least spatial, temporal, social and/or topical data obtained from a network-based tracking engine. Responsive to a determination that the user has performed the at least one activity or observed the at least one behavior, the user is provided with the at least one incentive.

### BACKGROUND OF THE INVENTION

1. Field of the Invention

The present invention generally relates to systems and methods for offering incentives to consumers or other entities, determining whether conditions necessary for redeeming the incentives have been fulfilled, and facilitating redemption of the incentives based on a determination that the redemption conditions have been fulfilled.

2. Background

Traditional print and online ad campaigns are typically intended to achieve a single goal—namely, to motivate a consumer to purchase a product or service. Such campaigns often offer a consumer an incentive, such as a discount, rebate, or reward. Redemption of the incentive is conditioned upon the purchase of the product or service by the consumer and usually involves presentation or invocation of the incentive offer by the consumer at the time of purchase.

The foregoing approach to incentive presentation and redemption cannot easily be adapted to encourage consumer behaviors that extend beyond the simple purchase of the product or service. This is largely due to the fact that there are only limited means available for determining whether or not a consumer has satisfied the conditions necessary for redeeming an incentive. Thus, conditions placed on the redemption of incentives are typically limited to simple conditions, the satisfaction of which can be easily determined at the time and place of purchase. These conditions often include simple temporal conditions involving when the incentive can be redeemed (e.g., a “valid through” date), simple spatial conditions involving where the incentive will be honored (e.g., participating locations), or other straightforward conditions such as which products or services must be purchased in order for the incentive to be redeemed.

Because the conditions for incentive redemption are typically limited in this fashion, advertisers and other entities have limited tools at their disposal for modifying the behavior of consumers through the use of incentives. For example, advertisers and other entities may not be able to use the above-mentioned incentive presentation/redemption model to modify non-commercial behaviors of users. Such simplistic incentive models are also disadvantageous in that they may garner only limited consumer interest and participation.

What is needed then is a system and method for presenting and redeeming conditional incentives that overcome the aforementioned shortcomings associated with conventional incentive presentation and redemption practices.

### BRIEF SUMMARY OF THE INVENTION

A computer-implemented method for incentivizing performance of an activity or observance of a behavior by a user is described herein. In accordance with the method, an offer is presented to a user via a user device. The terms of the offer include at least one activity to be performed by the user or at least one behavior to be observed by the user and at least one incentive to be rewarded to the user responsive to the performance of the at least one activity or the observance of the at least one behavior. Spatial, temporal, social and/or topical data associated with the user is then obtained from a network-based tracking engine. A determination is made as to whether the user has performed the at least one activity or observed the at least one behavior based on at least the obtained spatial, temporal, social and/or topical data. Responsive to a determination that the user has performed the at least one activity or observed the at least one behavior, the user is provided with the at least one incentive.

A system is also described herein. The system includes a user interface, a condition tracking engine and a redemption engine. The user interface is configured to present an offer to a user via a user device, wherein the terms of the offer comprise at least one activity to be performed by the user or at least one behavior to be observed by the user and at least one incentive to be rewarded to the user responsive to the performance of the at least one activity or the observance of the at least one behavior. The condition tracking engine is configured to obtain spatial, temporal, social and/or topical data from a network-based tracking engine and to determine if the user has performed the at least one activity or observed the at least one behavior based on at least the obtained spatial, temporal, social and/or topical data. The redemption engine is configured to provide the user with the at least one incentive responsive to a determination that the user has performed the at least one activity or observed the at least one behavior.

A computer-implemented method for facilitating creation of a conditional incentive offer for presentation to a user is also described herein. In accordance with the method, a plurality of conditions that may be associated with an incentive is presented, wherein fulfillment of each of the plurality of conditions by a user may be determined by at least obtaining spatial, temporal, social and/or topical data associated with the user from a network-based tracking engine. Input indicative of a selection of one or more of the plurality of conditions is received. The selected condition(s) are associated with a specified incentive. The selected condition(s) are stored in association with the specified incentive for subsequent presentation to a user as terms of a conditional incentive offer.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 is a high-level block diagram of a system for the distribution, tracking and redemption of conditional incentives in accordance with an embodiment of the present invention.

FIG. 2 is a block diagram that illustrates relationships between real world entities (RWEs) and information objects (IOs) on a “Who, What, When and Where” (W4) communication network (COMN) in accordance with an embodiment of the present invention.

FIG. 3 is a block diagram that illustrates the manner in which metadata may define the relationships between RWEs and IOs on a W4 COMN in accordance with an embodiment of the present invention.

FIG. 4 is a conceptual illustration of an example W4 COMN in accordance with an embodiment of the present invention.

FIG. 5 is a diagram that depicts the functional layers of an example W4 COMN in accordance with an embodiment of the present invention.

FIG. 6 is a block diagram that shows analysis components of a W4 engine in accordance with an embodiment of the present invention.

FIG. 7 is a block diagram of a W4 engine showing different components within sub-engines described in reference to FIG. 6.

FIG. 8 is a block diagram illustrating different types of data that may be collected by a W4 COMN in accordance with an embodiment of the present invention.

FIG. 9 is a block diagram of a conditional incentive engine in accordance with an embodiment of the present invention.

FIG. 10 is a block diagram of an example user interface of a conditional incentive engine in accordance with an embodiment of the present invention.

FIG. 11 depicts a flowchart of an example user registration process that may be implemented by a user interface of a conditional incentive engine in accordance with an embodiment of the present invention.

FIG. 12 depicts different types of information that may be stored within a user information database in accordance with an embodiment of the present invention.

FIG. 13 is a block diagram of an example sponsor interface of a conditional incentive engine in accordance with an embodiment of the present invention.

FIG. 14 depicts a flowchart of a method by which a sponsor interface facilitates creation of a conditional incentive offer for presentation to a user in accordance with an embodiment of the present invention.

FIG. 15 depicts different types of information that may be stored within a sponsor information database in accordance with an embodiment of the present invention.

FIG. 16 depicts a flowchart of a method for presenting, tracking and redeeming a conditional incentive in accordance with an embodiment of the present invention.

FIG. 17 depicts a flowchart of a method for determining whether a condition associated with a conditional incentive offer has been fulfilled by a user in accordance with an embodiment of the present invention.

FIG. 18 is a block diagram of an example computer system that may be used to implement aspects of the present invention.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### I. Introduction

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the art to implement such feature, structure, or characteristic in connection with other embodiments whether or not explicitly described.

A system in accordance with an embodiment of the present invention will now be described. The system advantageously allows advertisers or other entities to encourage various types of commercial and non-commercial behavior by consumers or other users of the system by offering conditional incentives to such users. In an embodiment, the system issues a conditional incentive offer to a user. The terms of the conditional incentive offer include at least one activity to be performed by the user or at least one behavior to be observed by the user and at least one incentive to be rewarded to the user responsive to the performance of the at least one activity or the observance of the at least one behavior. The system then automatically obtains spatial, temporal, social and/or topical data associated with the user from a network-based tracking engine and determines if the user has performed the at least one activity or observed the at least one behavior based at least on the obtained spatial, temporal, social and/or topical data. Responsive to determining that the user has performed the at least one activity or observed the at least one behavior, the system then provides the user with the at least one incentive.

Because the system has access to a comprehensive set of data maintained by the network-based tracking engine, it can be used to present and track the fulfillment of conditional incentive offers that include a wide variety of spatial, temporal, social and/or topical conditions. Thus, for example, conditional incentives may be offered that can only be redeemed if a user performs certain tasks at certain absolute or relative locations, at certain times, in certain social contexts, or when engaging in activities associated with certain topics. The conditions required for redemption of an incentive may beneficially be defined at a level of granularity that is commensurate with the level of granularity of the data maintained by the network-based tracking engine, thus allowing for very precise targeting of desired user behavior. Furthermore, complex combinations of conditions may be associated with an incentive, thereby allowing the redemption of an incentive to be tied to a series of user behaviors that span a variety of contexts.

The system thus allows advertisers or other entities to create conditional incentive based campaigns that are intended to encourage user behavior that extends far beyond simply purchasing a product or service. Such behavior may comprise for example, a variety of commercial or non-commercial behaviors. Because the system readily allows for the generation and implementation of creative and sophisticated new incentive models that extend beyond simple purchase/redemption models as described in the Background section above, the system may advantageously be used to gamer increased user interest and participation in incentive based campaigns.

### II. Example System Architecture

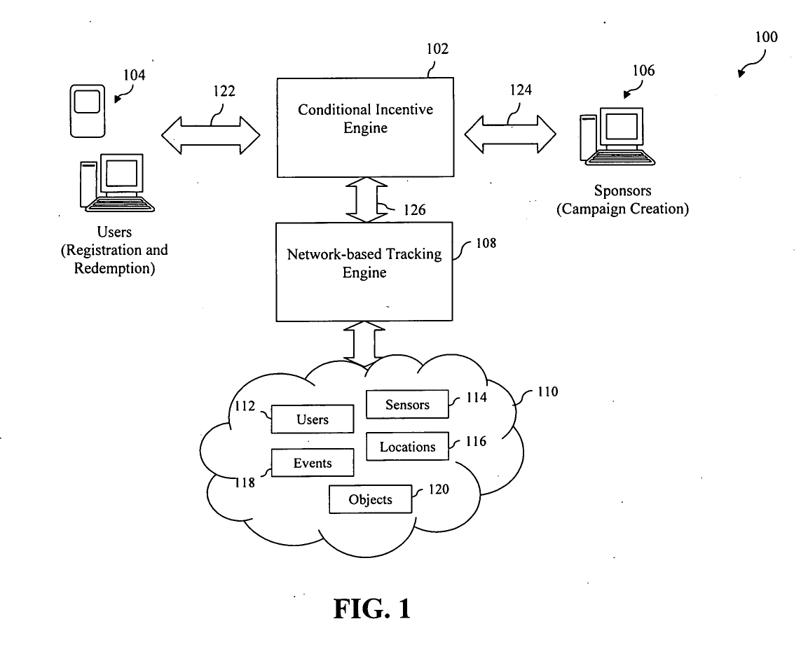

FIG. 1 is a high-level block diagram of an exemplary system 100 for the distribution, tracking and redemption of conditional incentives in accordance with one embodiment of the present invention. As used herein, the term “conditional incentive” broadly encompasses any incentive that may be offered to a user, the redemption of which is contingent upon the fulfillment of one or more conditions by the user and/or an associated entity or entities. Such incentives may include, for example, monetary incentives such as cash rewards, discounts or rebates on products and services, as well as non-monetary incentives. Such incentives may further include the avoidance of penalties or punishments (e.g., fines) resulting from non-fulfillment of certain associated conditions. When redeemed, the incentives may accrue directly to a user or to other entities (e.g., friends, relatives, community groups, charities or other third parties) associated with a user.

As shown in FIG. 1, system 100 includes a conditional incentive engine 102 that is communicatively connected to users 104 via a first interface 122, to sponsors 106 via a second interface 124, and to a network-based tracking engine 108 via a third interface 126. Each of the elements of system 100 will now be briefly described, with additional details to be provided in subsequent sections.

Users 104 comprise individuals or groups of individuals that utilize conditional incentive engine 102 to receive and selectively fulfill the conditions associated with conditional incentive offers provided by the engine. Sponsors 106 comprise advertisers or other entities that desire to offer conditional incentives to users via conditional incentive engine 102. Such other entities may include, for example, governmental agencies or offices, community groups, or individuals.

First interface 122 is configured to allow users 104 to interact with conditional incentive engine 102 to register to receive conditional incentive offers, to selectively participate in conditional incentive offers, to track personal progress towards redemption of selected conditional incentives, and to redeem conditional incentives when appropriate. In one embodiment of the present invention, first interface 122 includes an application programming interface (API) that can be used to build applications by which user systems/devices interact with conditional incentive engine 102, although the invention is not so limited.

Second interface 124 is configured to allow sponsors 106 to interact with conditional incentive engine 102 to create conditional incentive offers for presentation to users 104, to specify targeting criteria for matching such offers to certain users or user populations, to track the progress of users towards fulfillment of the conditions associated with the redemption of a conditional incentive, and to initiate or effect delivery of an incentive to a user upon fulfillment of such redemption conditions. In one embodiment of the present invention, second interface 124 includes an API that can be used to build applications by which sponsor systems interact with conditional incentive engine 102, although the invention is not so limited.

Conditional incentive engine 102 is a system that is configured to selectively present conditional incentive offers created or otherwise provided by sponsors 106 to users 104, to track the progress of users toward fulfillment of the conditions associated with selected conditional incentives, and to generate a notification to sponsors 106 and/or users 104 when all the requisite conditions for redemption of a conditional incentive have been fulfilled. To perform the tracking function, conditional incentive engine 102 is configured to obtain certain spatial, temporal, social and topical information associated with users from network-based tracking engine 108. Conditional incentive engine 102 may also be configured to remit redeemed incentives from sponsors 106 to users 104.

Network-based tracking engine 108 is configured to track certain spatial, temporal, social and topical data associated with users in a network 110 of tracked entities 110. Network 110 comprises one or more communications networks, including one or more personal area networks (PANs), local area networks (LAN), and/or wide area networks (WANs). As shown in FIG. 1, the tracked entities in network 110 may include users 112, sensors 114, locations 116, events 118, and objects 120. A detailed description of one implementation of network-based tracking engine 108 and network 110 is set forth below.

A. Network-Based Tracking Engine

Network-based tracking engine 108 and network 110 may be implemented in a variety of ways. In one embodiment, network-based tracking engine 108 and network 110 comprise aspects of a “W4 Communications Network” or W4 COMN, that uses information related to the “Who, What, When and Where” of interactions with the network to provide improved services to the network's users. The W4 COMN is a collection of users, devices and processes that foster both synchronous and asynchronous communications between users and their proxies. It includes an instrumented network of sensors providing data recognition and collection in real-world environments about any subject, location, user or combination thereof.

As a communication network, the W4 COMN handles the routing/addressing, scheduling, filtering, prioritization, replying, forwarding, storing, deleting, privacy, transacting, triggering of a new message, propagating changes, transcoding and linking. Furthermore, these actions can be performed on any communication channel accessible by the W4 COMN.

The W4 COMN uses a data modeling strategy for creating profiles for not only users and locations but also any device on the network and any kind of user-defined data with user-specified conditions from a rich set of possibilities. Using Social, Spatial, Temporal and Logical data available about a specific user, topic or logical data object, every entity known to the W4 COMN can be mapped and represented against all other known entities and data objects in order to create both a micro graph for every entity as well as a global graph that interrelates all known entities against each other and their attributed relations.

In order to describe the operation of the W4 COMN, two elements upon which the W4 COMN is built are first introduced, real-world entities and information objects. These distinctions are made in order to enable correlations to be made from which relationships between electronic/logical objects and real objects can be determined. A real-world entity (RWE) refers to a person, device, location, or other physical thing known to the W4 COMN (e.g., users 112, sensors 114, locations 116, and objects 120 shown in FIG. 1). Each RWE known to the W4 COMN may be assigned or otherwise provided with a unique W4 identification number that absolutely identifies the RWE within the W4 COMN.

RWEs can interact with the network directly or through proxies, which can themselves be RWEs. Examples of RWEs that interact directly with the W4 COMN include any device such as a sensor, motor, or other piece of hardware that connects to the W4 COMN in order to receive or transmit data or control signals. Because the W4 COMN can be adapted to use any and all types of data communication, the devices that can be RWEs include all devices that can serve as network nodes or generate, request and/or consume data in a networked environment or that can be controlled via the network. Such devices include any kind of “dumb” device purpose-designed to interact with a network (e.g., cell phones, cable television set top boxes, fax machines, telephones, and radio frequency identification (RFID) tags, sensors, etc.). Typically, such devices are primarily hardware and their operations cannot be considered separately from the physical device.

Examples of RWEs that typically use proxies to interact with W4 COMN network include non-electronic entities including physical entities, such as people (e.g., users 112), locations (e.g., locations 116) (e.g., states, cities, houses, buildings, airports, roads, etc.) and things (e.g., objects 120) (e.g., animals, pets, livestock, gardens, physical objects, cars, airplanes, works of art, etc.), and intangible entities such as business entities, legal entities, groups of people or sports teams. In addition, “smart” devices (e.g., computing devices such as smart phones, smart set top boxes, smart cars that support communication with other devices or networks, laptop computers, personal computers, server computers, satellites, etc.) are also considered RWEs that use proxies to interact with the network. Smart devices are electronic devices that can execute software via an internal processor in order to interact with a network. For smart devices, it is actually the executing software application(s) that interact with the W4 COMN and serve as the devices' proxies.

The W4 COMN allows associations between RWEs to be determined and tracked. For example, a given user (an RWE) can be associated with any number and type of other RWEs including other people, cell phones, smart credit cards, personal data assistants, email and other communication service accounts, networked computers, smart appliances, set top boxes and receivers for cable television and other media services, and any other networked device. This association can be made explicitly by the user, such as when the RWE is installed into the W4 COMN. An example of this is the set up of a new cell phone, cable television service or email account in which a user explicitly identifies an RWE (e.g., the user's phone for the cell phone service, the user's set top box and/or a location for cable service, or a username and password for the online service) as being directly associated with the user. This explicit association can include the user identifying a specific relationship between the user and the RWE (e.g., this is my device, this is my home appliance, this person is my friend/father/son/etc., this device is shared between me and other users, etc.). RWEs can also be implicitly associated with a user based on a current situation. For example, a weather sensor on the W4 COMN can be implicitly associated with a user based on information indicating that the user lives or is passing near the sensor's location.

An information object (IO), on the other hand, is a logical object that stores, maintains, generates, serves as a source for or otherwise provides data for use by RWEs and/or the W4 COMN. IOs are distinct from RWEs in that IOs represent data, whereas RWEs can create or consume data (often by creating or consuming IOs) during their interaction with the W4 COMN. Examples of IOs include passive objects such as communication signals (e.g., digital and analog telephone signals, streaming media and interprocess communications), email messages, transaction records, virtual cards, event records (e.g., a data file identifying a time, possibly in combination with one or more RWEs such as users and locations, that can further be associated with a known topic/activity/significance such as a concert, rally, meeting, sporting event, etc.), recordings of phone calls, calendar entries, web pages, database entries, electronic media objects (e.g., media files containing songs, videos, pictures, images, audio messages, phone calls, etc.), electronic files and associated metadata.

In addition, IOs include any executing process or application that consumes or generates data such as an email communication application (such as OUTLOOK by MICROSOFT, or YAHOO! MAIL by YAHOO!), a calendar application, a word processing application, an image editing application, a media player application, a weather monitoring application, a browser application and a web page server application. Such active IOs may or may not serve as a proxy for one or more RWEs. For example, voice communication software on a smart phone can serve as the proxy for both the smart phone and for the owner of the smart phone.

An IO in the W4 COMN can be provided a unique W4 identification number that absolutely identifies the IO within the W4 COMN. Although data in an IO can be revised by the act of an RWE, the IO remains a passive, logical data representation or data source and, thus, is not an RWE.

For every IO there are at least three classes of associated RWEs. The first is the RWE who owns or controls the IO, whether as the creator or a rights holder (e.g., an RWE with editing rights or use rights to the IO). The second is the RWE(s) that the IO relates to, for example by containing information about the RWE or that identifies the RWE. The third are any RWEs who then pay any attention (directly or through a proxy process) to the IO, in which “paying attention” refers to accessing the IO in order to obtain data from the IO for some purpose.

“Available data” and “W4 data” means data that exists in an IO in some form somewhere or data that can be collected as needed from a known IO or RWE such as a deployed sensor (e.g., sensors 114). “Sensor” means any source of W4 data including PCs, phones, portable PCs or other wireless devices, household devices, cars, appliances, security scanners, video surveillance, RFID tags in clothes, products and locations, online data or any other source of information about a real-world user/topic/thing (RWE) or logic-based agent/process/topic/thing (IO).

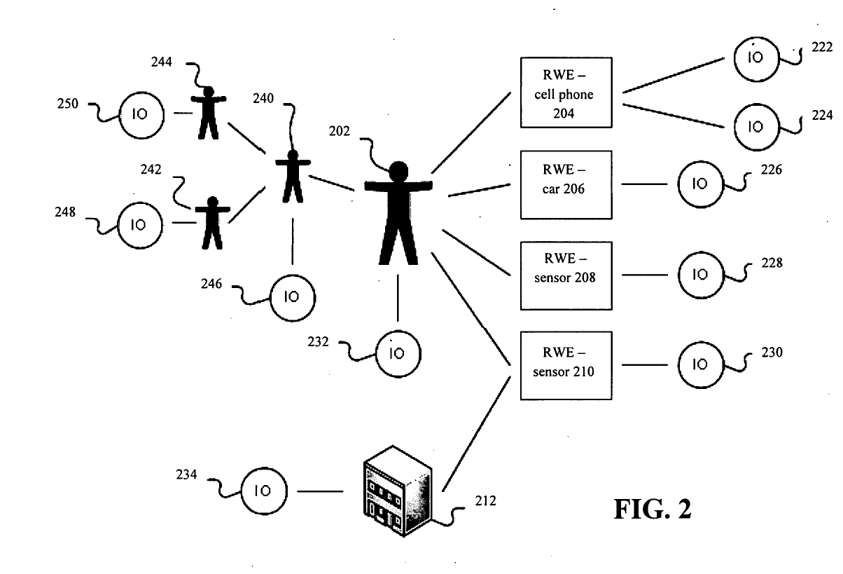

FIG. 2 illustrates an example of the relationships between RWEs and IOs on the W4 COMN. In the embodiment illustrated in FIG. 2, a user 202 is a RWE of the network provided with a unique network ID. User 202 is a human that communicates with the network via proxy devices 204, 206, 208, 210 associated with the user 202, all of which are RWEs of the network and provided with their own unique network ID. Some of these proxies can communicate directly with the W4 COMN or can communicate with the W4 COMN via IOs such as applications executed on or by the device.

As mentioned above, proxy devices 204, 206, 208, 210 can be explicitly associated with user 202. For example, device 204 can be a smart phone connected by a cellular service provider to the network and another device 206 can be a smart vehicle that is connected to the network. Other devices can be implicitly associated with the user 202. For example, device 208 can be a “dumb” weather sensor at a location matching the current location of the user's cell phone 204, and thus implicitly associated with user 202 while RWEs 204, 208 are co-located. Another implicitly associated device 210 can be a sensor 210 for a physical location 212 known to the W4 COMN. Location 212 is known, either explicitly (through a user-designated relationship, e.g., this is my home, place of employment, parent, etc.) or implicitly (the user 202 is often co-located with the RWE 212 as evidenced by data from the sensor 210 at that location 212), to be associated with the first user 202.

User 202 can also be directly associated with other people, such as the person 240 shown, and then indirectly associated with other people 242, 244 through their associations as shown. Again, such associations can be explicit (e.g., the user 202 can have identified the associated person 240 as his/her father, or can have identified the person 240 as a member of the user's social network) or implicit (e.g., they share the same address).

Tracking the associations between people (and other RWEs as well) allows the creation of the concept of “intimacy.” Intimacy is a measure of the degree of association between two people or RWEs. For example, each degree of removal between RWEs can be considered a lower level of intimacy, and assigned lower intimacy score. Intimacy can be based solely on explicit social data or can be expanded to include all W4 data including spatial data and temporal data.

Each RWE 202, 204, 206, 208, 210, 212, 240, 242, 244 of the W4 COMN can be associated with one or more IOs as shown. Continuing the examples discussed above, FIG. 2 illustrates two IOs 222, 224 as associated with the cell phone device 204. One IO 222 can be a passive data object such as an event record that is used by scheduling/calendaring software on the cell phone, a contact IO used by an address book application, a historical record of a transaction made using device 204 or a copy of a message sent from device 204. The other IO 224 can be an active software process or application that serves as the device's proxy to the W4 COMN by transmitting or receiving data via the W4 COMN. Voice communication software, scheduling/calendaring software, an address book application or a text messaging application are all examples of IOs that can communicate with other IOs and RWEs on the network. IOs 222, 224 can be locally stored on device 204 or stored remotely on some node or data store accessible to the W4 COMN, such as a message server or cell phone service datacenter. IO 226 associated with vehicle 206 can be an electronic file containing the specifications and/or current status of vehicle 206, such as make, model, identification number, current location, current speed, current condition, current owner, etc. IO 228 associated with sensor 208 can identify the current state of the subject(s) monitored by sensor 208, such as current weather or current traffic. IO 222 associated with cell phone 204 can also be information in a database identifying recent calls or the amount of charges on the current bill.

Furthermore, those RWEs which can only interact with the W4 COMN through proxies, such as people 202, 240, 242, 244, computing devices 204, 206 and location 212, can have one or more IOs 232, 234, 246, 248, 250 directly associated with them. An example includes IOs 232, 234 that contain contact and other RWE-specific information. For example, a person's IO 232, 246, 248, 250 can be a user profile containing email addresses, telephone numbers, physical addresses, user preferences, identification of devices and other RWEs associated with the user, records of the user's past interactions with other RWE's on the W4 COMN (e.g., transaction records, copies of messages, listings of time and location combinations recording the user's whereabouts in the past), the unique W4 COMN identifier for the location and/or any relationship information (e.g., explicit user-designations of the user's relationships with relatives, employers, co-workers, neighbors, service providers, etc.). Another example of a person's IO 232, 246, 248, 250 includes remote applications through which a person can communicate with the W4 COMN such as an account with a web-based email service such as Yahoo! Mail. The location's IO 234 can contain information such as the exact coordinates of the location, driving directions to the location, a classification of the location (residence, place of business, public, non-public, etc.), information about the services or products that can be obtained at the location, the unique W4 COMN identifier for the location, businesses located at the location, photographs of the location, etc.

In order to correlate RWEs and IOs to identify relationships, the W4 COMN makes extensive use of existing metadata and generates additional metadata where necessary. Metadata is loosely defined as data that describes data. For example, given an IO such as a music file, the core, primary or object data of the music file is the actual music data that is converted by a media player into audio that is heard by the listener. Metadata for the same music file can include data identifying the artist, song, etc., album art, and the format of the music data. This metadata can be stored as part of the music file or in one or more different IOs that are associated with the music file or both. In addition, W4 metadata for the same music file can include the owner of the music file and the rights the owner has in the music file. As another example, if the IO is a picture taken by an electronic camera, the picture can include in addition to the primary image data from which an image can be created on a display, metadata identifying when the picture was taken, where the camera was when the picture was taken, what camera took the picture, who, if anyone, is associated (e.g., designated as the camera's owner) with the camera, and who and what are the subjects of/in the picture. The W4 COMN uses all the available metadata in order to identify implicit and explicit associations between entities and data objects.

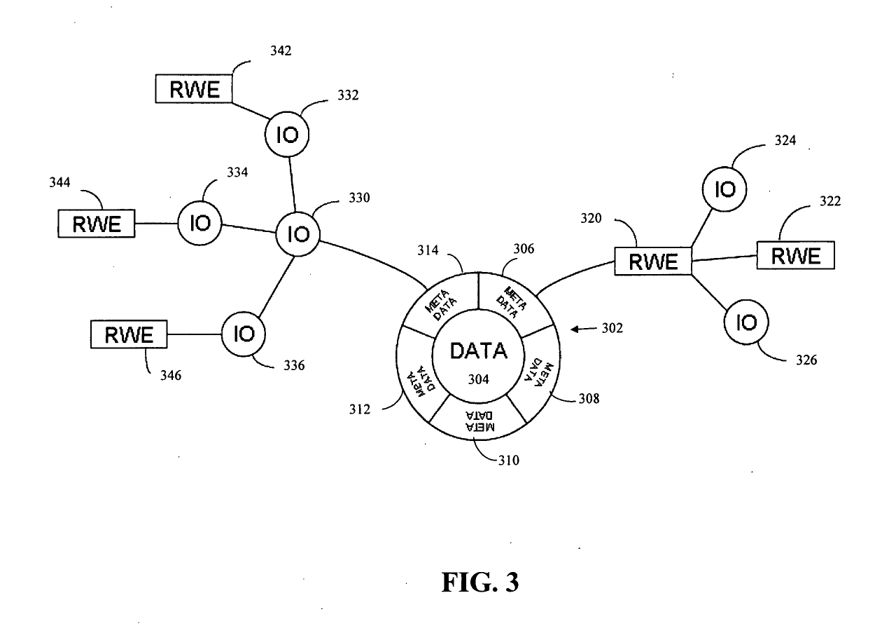

FIG. 3 illustrates an example of metadata defining the relationships between RWEs and IOs on the W4 COMN. In the embodiment shown, an IO 302 includes object data 304 and five discrete items of metadata 306, 308, 310, 312, 314. Some items of metadata 308, 310, 312 can contain information related only to the object data 304 and unrelated to any other IO or RWE. For example, a creation date, text or an image that is to be associated with object data 304 of IO 302.

Some of items of metadata 306, 314, on the other hand, can identify relationships between IO 302 and other RWEs and IOs. As illustrated, IO 302 is associated by one item of metadata 306 with an RWE 320 and RWE 320 is further associated with two IOs 324, 326 and a second RWE 322 based on some information known to the W4 COMN. This part of FIG. 3, for example, could describe the relations between a picture (IO 302) containing metadata 306 that identifies the electronic camera (the first RWE 320) and the user (the second RWE 322) that is known by the system to be the owner of the camera 320. Such ownership information can be determined, for example, from one or another of IOs 324, 326 associated with camera 320.

FIG. 3 also illustrates metadata 314 that associates IO 302 with another IO 330. This IO 330 is itself associated with three other IOs 332, 334, 336 that are further associated with different RWEs 342, 344, 346, respectively. This part of FIG. 3, for example, could describe the relations between a music file (IO 302) containing metadata 306 that identifies the digital rights file (first IO 330) that defines the scope of the rights of use associated with this music file 302. The other IOs 332, 334, 336 are other music files that are associated with the rights of use and which are currently associated with specific owners (RWEs 342, 344, 346).

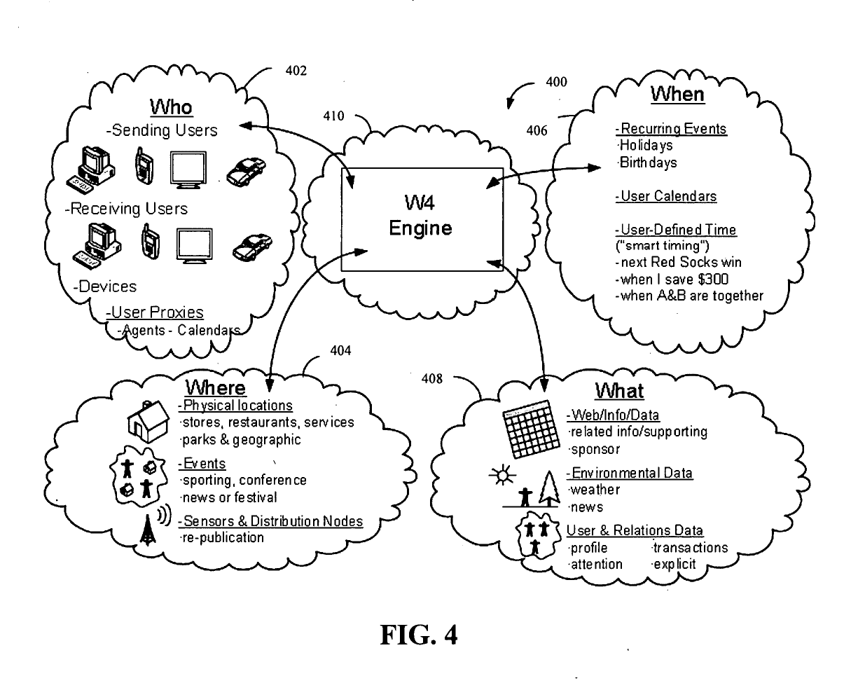

FIG. 4 illustrates an example conceptual model of the W4 COMN, shown in FIG. 4 as a W4 COMN 400. As shown in FIG. 4, W4 COMN 400 includes a Who cloud 402, a Where cloud 404, a When cloud 406, a What cloud 408, and a W4 engine 410. W4 COMN 400 creates an instrumented messaging infrastructure in the form of a global logical network cloud conceptually sub-divided into networked-clouds for each of the 4Ws: Who (Who cloud 402), Where (Where cloud 404), What (What cloud 408), and When (When cloud 406). This global logical network cloud is an example of network 110 shown in FIG. 1. Who cloud 402 includes all users (e.g., users 112), whether acting as senders, receivers, data points or confirmation/certification sources as well as user proxies in the forms of user-program processes, devices, agents, calendars, etc. Where cloud 404 includes all physical locations, events (e.g., events 118), sensors (e.g., sensors 114) or other RWEs associated with a spatial reference point or location. When cloud 406 includes natural temporal events (e.g., events 118) (that is events that are not associated with particular location or person such as days, times, seasons) as well as collective user temporal events (holidays, anniversaries, elections, etc.) and user-defined temporal events (birthdays, smart-timing programs). What cloud 408 includes known data—web or private, commercial or user—accessible to the W4 COMN, including for example environmental data like weather and news, RWE-generated data, IOs and IO data, user data, models, processes and applications. Thus, conceptually, most data is contained in the What cloud 408.

As this is just a conceptual model, it should be noted that some entities, sensors or data will naturally exist in multiple clouds either disparate in time or simultaneously. Additionally, some IOs and RWEs can be composites in that they combine elements from one or more clouds. Such composites can be classified or not as appropriate to facilitate the determination of associations between RWEs and IOs. For example, an event consisting of a location and time could be equally classified within When cloud 406, What cloud 408 and/or Where cloud 404.

W4 engine 410 is an example of network-based tracking engine 108 shown in FIG. 1. W4 engine 410 is center of the W4 COMN's central intelligence for making all decisions in the W4 COMN. An “engine” as referred to herein is meant to describe a software, hardware or firmware (or combinations thereof) system, process or functionality that performs or facilitates the processes, features and/or functions described herein (with or without human interaction or augmentation). W4 engine 410 controls all interactions between each layer of the W4 COMN and is responsible for executing any approved user or application objective enabled by W4 COMN operations or interoperating applications. In an embodiment, the W4 COMN is an open platform upon which anyone can write an application. To support this, it includes standard published APIs for requesting (among other things) synchronization, disambiguation, user or topic addressing, access rights, prioritization or other value-based ranking, smart scheduling, automation and topical, social, spatial or temporal alerts.

One function of W4 engine 410 is to collect data concerning all communications and interactions conducted via W4 COMN 400, which can include storing copies of IOs and information identifying all RWEs and other information related to the IOs (e.g., who, what, when, where information). Other data collected by the W4 COMN can include information about the status of any given RWE and IO at any given time, such as the location, operational state, monitored conditions (e.g., for an RWE that is a weather sensor, the current weather conditions being monitored or for an RWE that is a cell phone, its current location based on the cellular towers it is in contact with) and current status.

W4 engine 410 is also responsible for identifying RWEs and relationships between RWEs and IOs from the data and communication streams passing through the W4 COMN. The function of identifying RWEs associated with or implicated by IOs and actions performed by other RWEs is referred to as entity extraction. Entity extraction includes both simple actions, such as identifying the sender and receivers of a particular IO, and more complicated analyses of the data collected by and/or available to the W4 COMN, for example determining that a message listed the time and location of an upcoming event and associating that event with the sender and receiver(s) of the message based on the context of the message or determining that an RWE is stuck in a traffic jam based on a correlation of the RWE's location with the status of a co-located traffic monitor.

It should be noted that when performing entity extraction from an IO, the IO can be an opaque object with only W4 metadata related to the object (e.g., date of creation, owner, recipient, transmitting and receiving RWEs, type of IO, etc.), but no knowledge of the internals of the IO (i.e., the actual primary or object data contained within the object). Knowing the content of the IO does not prevent W4 data about the IO (or RWE) to be gathered. The content of the IO if known can also be used in entity extraction, if available, but regardless of the data available entity extraction is performed by the network based on the available data. Likewise, W4 data extracted around the object can be used to imply attributes about the object itself, while in other embodiments, full access to the IO is possible and RWEs can thus also be extracted by analyzing the content of the object, e.g. strings within an email are extracted and associated as RWEs to for use in determining the relationships between the sender, user, topic or other RWE or IO impacted by the object or process.

In an embodiment, W4 engine 410 represents a group of applications executing on one or more computing devices that are nodes of the W4 COMN. For the purposes of this disclosure, a computing device is a device that includes a processor and memory for storing data and executing software (e.g., applications) that perform the functions described. Computing devices can be provided with operating systems that allow the execution of software applications in order to manipulate data.

In the embodiment shown, W4 engine 410 can be one or a group of distributed computing devices, such as one or more general-purpose personal computers (PCs) or purpose built server computers, connected to the W4 COMN by suitable communication hardware and/or software. Such computing devices can be a single device or a group of devices acting together. Computing devices can be provided with any number of program modules and data files stored in a local or remote mass storage device and local memory (e.g., RAM) of the computing device. For example, as mentioned above, a computing device can include an operating system suitable for controlling the operation of a networked computer, such as the WINDOWS XP or WINDOWS SERVER operating systems from MICROSOFT CORPORATION.

Some RWEs can also be computing devices such as smart phones, web-enabled appliances, PCs, laptop computers, and personal data assistants (PDAs). Computing devices can be connected to one or more communications networks such as the Internet, a publicly switched telephone network, a cellular telephone network, a satellite communication network, a wired communication network such as a cable television or private area network. Computing devices can be connected any such network via a wired data connection or wireless connection such as a Wi-Fi (IEEE 802.11), a WiMAX (IEEE 802.36), a BLUETOOTH or a cellular telephone connection.

Local data structures, including discrete IOs, can be stored on a mass storage device (not shown) that is connected to, or part of, any of the computing devices described herein including W4 engine 410. For example, in an embodiment, the data backbone of the W4 COMN, discussed below, includes multiple mass storage devices that maintain the IOs, metadata and data necessary to determine relationships between RWEs and IOs as described herein. A mass storage device includes some form of computer-readable media and provides non-volatile storage of data and software for retrieval and later use by one or more computing devices. Although the description of computer-readable media contained herein refers to a mass storage device, such as a hard disk or CD-ROM drive, it should be appreciated by those skilled in the art that computer-readable media can be any available media that can be accessed by a computing device.

By way of example, and not limitation, computer-readable media can comprise computer storage media and communication media. Computer storage media include volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassette, magnetic tape, magnetic disk storage or other magnetic storage devices, or any other medium which can be used to store the desired information and which can be accessed by the computer.

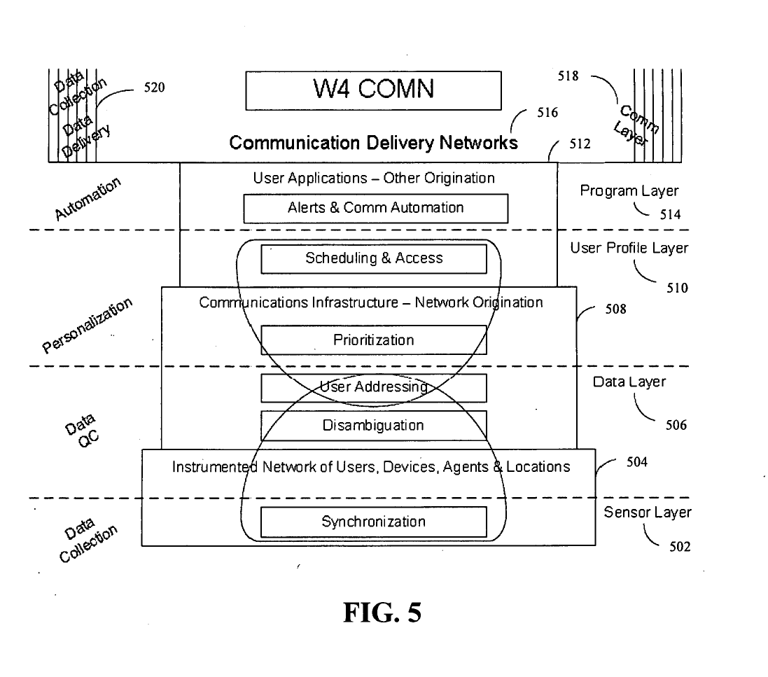

FIG. 5 illustrates the functional layers of an example W4 COMN architecture. At the lowest layer, referred to as a sensor layer 502, is a network 504 of the actual devices, users, nodes and other RWEs. The instrumentation of the network nodes to utilize them as sensors include known technologies like web analytics, GPS, cell-tower pings, use logs, credit card transactions, online purchases, explicit user profiles and implicit user profiling achieved through behavioral targeting, search analysis and other analytics models used to optimize specific network applications or functions.

The next layer is a data layer 506 in which the data produced by sensor layer 502 is stored and cataloged. The data can be managed by either network 504 of sensors or a network infrastructure 508 that is built on top of the instrumented network of users, devices, agents, locations, processes and sensors. Network infrastructure 508 is the core under-the-covers network infrastructure that includes the hardware and software necessary to receive data transmitted from the sensors, devices, etc. of network 504. It further includes the processing and storage capability necessary to meaningfully categorize and track the data created by network 504.

The next layer of the W4 COMN is a user profiling layer 510. Layer 510 can further be distributed between network infrastructure 508 and user applications/processes 512 executing on the W4 engine or disparate user computing devices. User profiling layer 510 performs the W4 COMN's user profiling functions. Personalization is enabled across any single or combination of communication channels and modes including email, IM, texting (SMS, etc.), photo-blogging, audio (e.g. telephone call), video (teleconferencing, live broadcast), games, data confidence processes, security, certification or any other W4 COMM process call for available data.

In one embodiment, user profiling layer 510 is a logic-based layer above all sensors to which sensor data are sent in the rawest form to be mapped and placed into a W4 COMN data backbone 520. The data (collected and refined, related and de-duplicated, synchronized and disambiguated) are then stored in one or a collection of related databases available to all processes of all applications approved on the W4 COMN. All network-originating actions and communications are based upon the fields of the data backbone, and some of these actions are such that they themselves become records somewhere in the backbone, e.g. invoicing, while others, e.g. fraud detection, synchronization, disambiguation, can be done without an impact to profiles and models within the backbone.

Actions originating from anything other than the network, e.g., RWEs such as users, locations, proxies and processes, come from program layer 514 of the W4 COMN. Some applications can be developed by the W4 COMN operator and appear to be implemented as part of network infrastructure 508, e.g. email or calendar programs, because of how closely they operate with the sensor processing and user profiling layer 510. Applications 512 also serve some role as a sensor in that they, through their actions, generate data back to data layer 506 via the data backbone concerning any data created or available due to the applications execution.

Program layer 514 also provides a personalized user interface (UI) based upon device, network, carrier as well as user-selected or security-based customizations. Any UI can operate within the W4 COMN if it is instrumented to provide data on user interactions or actions back to the network. This is a basic sensor function of any W4 COMN application/UI, and although the W4 COMN can interoperate with applications/UIs that are not instrumented, it is only in a delivery capacity and those applications/UIs would not be able to provide any data (let alone the rich data otherwise available from W4-enabled devices).

In the case of W4 COMN mobile devices, the UI can also be used to confirm or disambiguate incomplete W4 data in real-time, as well as correlation, triangulation and synchronization sensors for other nearby enabled or non-enabled devices. At some point, the network effects of enough enabled devices allow the network to gather complete or nearly complete data (sufficient for profiling and tracking) of a non-enabled device because of its regular intersection and sensing by enabled devices in its real-world location.

Above the program layer 514 (and sometimes hosted within it) is a communications delivery network(s) 516. This can be operated by the W4 COMN operator or be independent third-party carrier service, but in either case it functions to deliver the data via synchronous or asynchronous communication. Communication delivery network 516 sends or receives data (e.g., http or IP packets) on behalf of a specific application or network infrastructure 508 request.

Communication delivery layer 518 also has elements that act as sensors including W4 entity extraction from phone calls, emails, blogs, etc. as well as specific user commands within the delivery network context, e.g., “save and prioritize this call” said before end of call can trigger a recording of the previous conversation to be saved and for the W4 entities within the conversation to analyzed and increased in weighting prioritization decisions in personalization/user profiling layer 51 0.

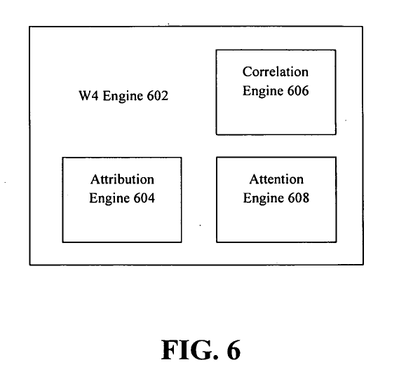

FIG. 6 illustrates an embodiment of analysis components of a W4 engine as shown in FIG. 4. FIG. 6 shows a block diagram of a W4 engine 602. As shown in FIG. 6, W4 engine 602 includes an attribution engine 604, a correlation engine 606, and an attention engine 608. W4 engine 602 is another example embodiment of network-based tracking engine 108. As discussed above, the W4 Engine is responsible for identifying RWEs and relationships between RWEs and IOs from the data and communication streams passing through the W4 COMN.

In one embodiment the W4 engine connects, interoperates and instruments all network participants through a series of sub-engines that perform different operations in the entity extraction process. One such sub-engine is attribution engine 604. The attribution engine 604 tracks the real-world ownership, control, publishing or other conditional rights of any RWE in any IO. Whenever a new IO is detected by W4 engine 602, e.g., through creation or transmission of a new message, a new transaction record, a new image file, etc., ownership is assigned to the IO. Attribution engine 604 creates this ownership information and further allows this information to be determined for each IO known to the W4 COMN.

As described above, W4 engine 602 further includes correlation engine 606. Correlation engine 606 operates in two capacities: first, to identify associated RWEs and IOs and their relationships (such as by creating a combined graph of any combination of RWEs and IOs and their attributes, relationships and reputations within contexts or situations) and second, as a sensor analytics pre-processor for attention events from any internal or external source.

In one embodiment, the identification of associated RWEs and IOs function of correlation engine 606 is done by graphing the available data. In this embodiment, a histogram of all RWEs and IOs is created, from which correlations based on the graph can be made. Graphing, or the act of creating a histogram, is a computer science method of identifying a distribution of data in order to identify relevant information and make correlations between the data. In a more general mathematical sense, a histogram is simply a mapping mi that counts the number of observations that fall into various disjoint categories (known as bins), whereas the graph of a histogram is merely one way to represent a histogram. By selecting each IO, RWE, and other known parameters (e.g., times, dates, locations, etc.) as different bins and mapping the available data, relationships between RWEs, IOs and the other parameters can be identified.

As a pre-processor, correlation engine 606 monitors the information provided by RWEs in order to determine if any conditions are identified that can trigger an action on the part of W4 engine 602. For example, if a delivery condition has been associated with a message, when correlation engine 606 determines that the condition is met, it can transmit the appropriate trigger information to W4 engine 602 that triggers delivery of the message.

The attention engine 608 instruments all appropriate network nodes, clouds, users, applications or any combination thereof and includes close interaction with both correlation engine 606 and attribution engine 604.

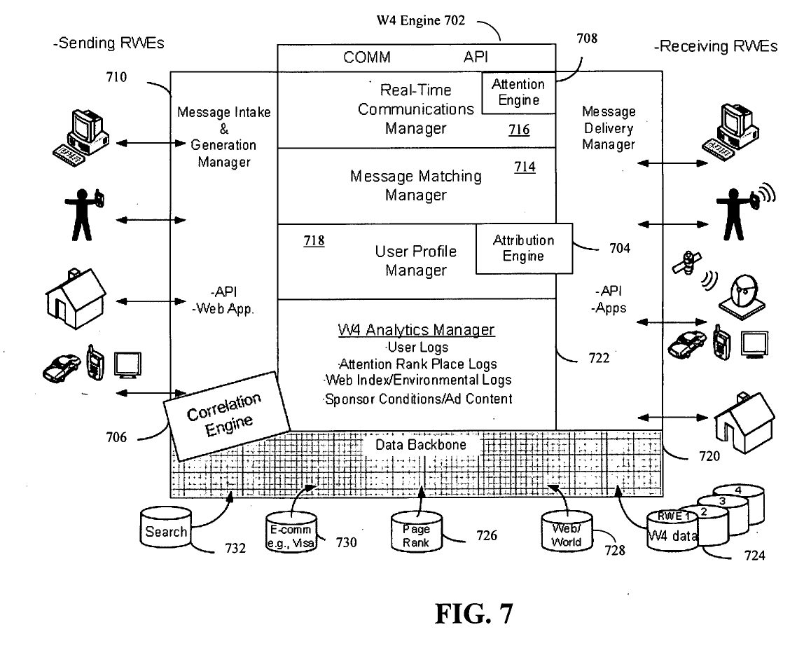

FIG. 7 illustrates an embodiment of a W4 engine showing different components within the sub-engines described generally above with reference to FIG. 6. In one embodiment, W4 engine 702 includes an attention engine 708, attribution engine 704 and correlation engine 706 with several sub-managers based upon basic function.

Attention engine 708 includes a message intake and generation manager 710 as well as a message delivery manager 712 that work closely with both a message matching manager 714 and a real-time communications manager 716 to deliver and instrument all communications across the W4 COMN.

Attribution engine 704 works within user profile manager 718 and in conjunction with all other modules to identify, process/verify and represent ownership and rights information related to RWEs, IOs and combinations thereof.

Correlation engine 706 stores data from both of its channels (sensors and processes) into the same data backbone 720 which is organized and controlled by W4 analytics manager 722 and includes both aggregated and individualized archived versions of data from all network operations including user logs 724, attention rank place logs 726, web indices and environmental logs 728, e-commerce and financial transaction information 730, search indexes and logs 732, sponsor content or conditionals, ad copy and any and all other data used in any W4 COMN process, IO or event. Because of the amount of data that the W4 COMN will potentially store, data backbone 720 includes numerous database servers and data stores in communication with the W4 COMN to provide sufficient storage capacity.

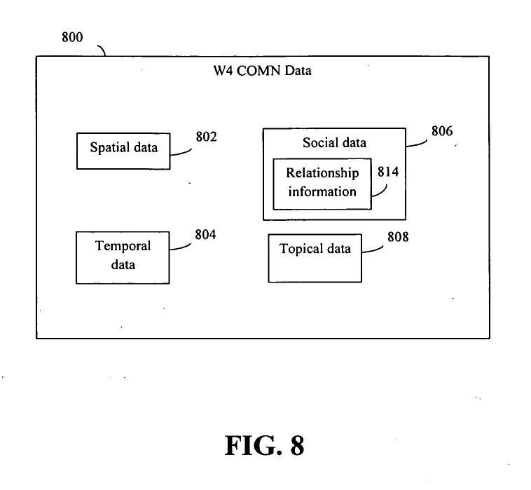

As shown in FIG. 8, data collected by the W4 COMN may include spatial data 802, temporal data 804, social data 806 and topical data 808. Each of the elements of W4 COMN data 800 shown in FIG. 8 is not necessarily present in all embodiments. The elements of W4 COMN data 800 shown in FIG. 8 will now be described.

Spatial data 802 may be any information associated with a location of a user and/or an electronic device associated with the user. For example, spatial data 802 may include any passively-collected location data, such as cell tower data, GPRS data, global positioning service (GPS) data, WI-FI data, personal area network data, IP address data and data from other network access points, or actively-collected location data, such as location data entered into a device by a user. Spatial data 802 may be obtained by tracking the path and state of an electronic device associated with the user.

Temporal data 804 is time-based data (e.g., time stamps) or metadata (e.g., expiration dates) that relates to specific times and/or events associated with a user and/or an electronic device associated with the user. For example, temporal data 804 may include passively-collected time data (e.g., time data from a clock resident on an electronic device, or time data from a network clock), or actively-collected time data, such as time data entered by the user of the electronic device (e.g., a user-maintained calendar).

Social data 806 may be any data or metadata relating to the relationships of a user. For example, social data 806 may include user identity data, such as gender, age, race, name, an alias, a status of the user (e.g., an online status or a non-online related status) (e.g., at work, at sleep, on vacation, etc.), a social security number, image information (such as a filename for a picture, avatar, or other image representative of the user), and/or other information associated with the user's identity. User identity information may also include e-mail addresses, login names and passwords. Social data 806 may also include social network data. Social network data may include data relating to any relation of the user that is input by a user, such as data relating to a user's friends, family, co-workers, business relations, and the like. Social network data may include, for example, data corresponding with a user-maintained electronic address book. Certain social data may be correlated with, for example, location information to deduce social network data, such as primary relationships (e.g., user-spouse, user-children and user-parent relationships) or other relationships (e.g., user-friends, user-co-worker, user-business associate relationships) and may be weighted by primacy.

For example, as shown in FIG. 8, social data 806 may include relationship information 814. Relationship information 814 includes a list or other data structure indicating friends of the user, including friends that are other users participating in a social network. Relationship information 814 may include categories for the indicated friends, such as “relatives,” “spouse,” “parents,” “children,” “cousins,” “best friends,” “boss,” “co-workers,” and/or any other suitable category.

Social data 806 may further include reputation information regarding the user within the confines of a social network. For example, other users in a social network may be able to comment on and/or provide a rating for the user. An overall rating may be determined for the user, which may represent a reputation for the user in the social network.

Topical data 808 may be any data or metadata concerning subject matter in which a user appears to have an interest or is otherwise associated. Topical data 808 may be actively provided by a user or may be derived from other sources. For example, topical data 808 may include one or more transaction log(s) of transactions involving the user. For example, such transaction log(s) may include logs of searches (e.g., query lists/results lists) performed by the user, logs of commerce undertaken by the user, logs of website/webpage browsing by the user, logs of communications (e.g., with friends in a social network) by the user, etc.

Both social data 806 and topical data 808 may be derived from interaction data. As used herein, the term interaction data refers to any data associated with interactions carried out by a user via an electronic device, whether active or passive. Examples of interaction data include interpersonal communication data, media data, transaction data and device interaction data.

Interpersonal communication data may be any data or metadata that is received from or sent by an electronic device and that is intended as a communication to or from the user. For example, interpersonal communication data may include any data associated with an incoming or outgoing SMS message, e-mail message, voice call (e.g., a cell phone call, a voice over IP call), or other type of interpersonal communication relative to an electronic device, such as information regarding who is sending and receiving the interpersonal communication(s). As described below, interpersonal communication data may be correlated with, for example, temporal data to deduce information regarding frequency of communications, including concentrated communication patterns, which may indicate user activity information.

Media data may be any data or metadata relating to presentable media, such as audio data, visual data and audiovisual data. Audio data may be, for example, data relating to downloaded music, such as genre, artist, album and the like, and may include data regarding ringtones, ring backs, media purchased, playlists, and media shared, to name a few. Visual data may be data relating to images and/or text received by an electronic device (e.g., via the Internet or other network). Visual data may include data relating to images and/or text sent from and/or captured at an electronic device. Audiovisual data may include data or metadata associated with any videos captured at, downloaded to, or otherwise associated with an electronic device.

Media data may also include media presented to a user via a network, such as via the Internet, data relating to text entered and/or received by a user using the network (e.g., search terms), and data relating to interaction with the network media, such as click data (e.g., advertisement banner clicks, bookmarks, click patterns and the like). Thus, media data may include data relating to a user's RSS feeds, subscriptions, group memberships, game services, alerts, and the like. Media data may also include non-network activity, such as image capture and/or video capture using an electronic device, such as a mobile phone. Image data may include metadata added by a user, or other data associated with an image, such as, with respect to photos, location at which the photos were taken, direction of the shot, content of the shot, and time of day, to name a few. As described in further detail below, media data may be used for example, to deduce activities information or preferences information, such as cultural and/or buying preferences information.

Interaction data may also include transactional data or metadata. Transactional data may be any data associated with commercial transactions undertaken by a user via an electronic device, such as vendor information, financial institution information (e.g., bank information), financial account information (e.g., credit card information), merchandise information and cost/prices information, and purchase frequency information, to name a few. Transactional data may be utilized, for example, to deduce activities and preferences information. Transactional information may also be used to deduce types of devices and/or services owned by a user and/or in which a user may have an interest.

Interaction data may also include device interaction data and metadata. Device interaction data may be any data relating to a user's interaction with an electronic device not included in any of the above categories, such as data relating to habitual patterns associated with use of an electronic device. Example of device interaction data include data regarding which applications are used on an electronic system/device and how often and when those applications are used. As described in further detail below, device interaction data may be correlated with temporal data to deduce information regarding user activities and patterns associated therewith.

W4 COMN data 800 may also include deduced information. The deduced information may be deduced based on one or more of spatial data 802, temporal data 8904, social data 806, or topical data 808 as described above. The deduced information may thus include information relating to deduced locations and/or deduced activities of the user. For example, the deduced information may comprise one or more of a primary user location, secondary user location, past locations, present location, and predicted future location information. The deduced information may include information deduced based on a correlation of spatial data 802 in conjunction with temporal data 804 to deduce such location data. By way of illustration, spatial data 802 may be correlated with temporal data 804 to determine that a user is often at one or more specific locations during certain hours of the day. In a particular embodiment, spatial data 802 is correlated with temporal data 804 to determine a primary user location (e.g., home), a secondary location (e.g., school or work) and/or other locations, as well as a cyclical model for a user's spatial/temporal patterns.

The deduced information may also include activity information, such as past activity information, present activity information, and predicted future activity information. In this regard, the past, present, or predicted future activity information may include information relating to past communications and/or co-locations with other users. By way of example, spatial data 802 may be correlated with temporal data 804 to determine a user's activities (e.g., work, recreation and/or home activities).

The deduced information may also include preferences information. The preferences information may include cultural preferences and/or buying preferences information. The cultural preferences information may be any preferences information relating to the culture of the user, such as gender preferences, ethnicity preferences, religious preferences and/or artistic preferences, to name a few. The buying preferences may be any preferences associated with the buying habits of the user. All preferences may be explicitly provided by a user or implicitly derived from aggregated user and network data.

B. Conditional Incentive Engine

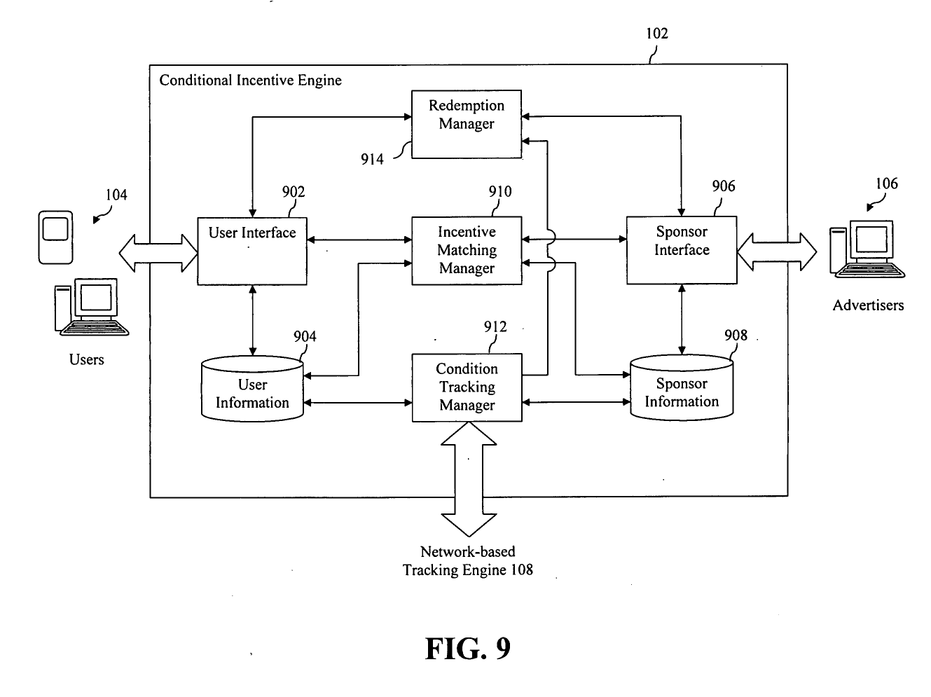

FIG. 9 depicts conditional incentive engine 102 in more detail. As shown in FIG. 9, conditional incentive engine 102 includes a number of communicatively-connected elements including a user interface 902, a user information database 904, a sponsor interface 906, a sponsor information database 908, an incentive matching manager 910, a condition tracking manager 912 and a redemption manager 914. Each of these elements will now be described.

1. User Interface

User interface 902 is a component that is configured to allow a user to interact with conditional incentive engine 102 from a remote location for the purposes of registering to receive conditional incentive offers, selectively participating in conditional incentive offers, tracking personal progress towards redemption of selected conditional incentives, and redeeming conditional incentives when appropriate. In one embodiment, user interface 902 is implemented using a Web service and a standard set of Web APIs for utilizing the Web service. Web applications built upon the Web service may be published by an entity that owns and/or operates conditional incentive engine 102 or by other entities. Such Web applications are accessed by users using Web browsers in a well-known fashion. However, this is only one example, and user interface 902 may be implemented in other ways.

Any of a wide variety of user systems/devices may be used to interact with user interface 902, including but not limited to electronic systems/devices having wired or wireless network communication functionality. In one embodiment, communication between users and user interface 902 occurs over the Internet. However, the invention is not so limited, and communication between users and user interface 902 may occur over any type of network or combination of networks including wide area networks, local area networks, private networks, public networks, packet networks, circuit-switched networks, and wired or wireless networks.

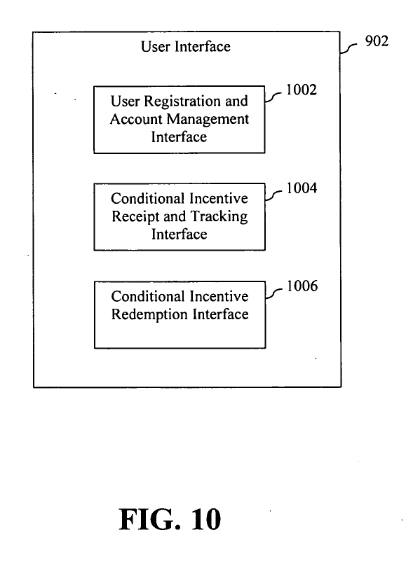

As shown in FIG. 10, in one embodiment, user interface 902 comprises at least three separate distinct user interface components—namely, a user registration and account management interface 1002, a conditional incentive receipt and tracking interface 1004 and a conditional incentive redemption interface 1006. Each of these different interface components will now be described.

a. User Registration and Account Management Interface

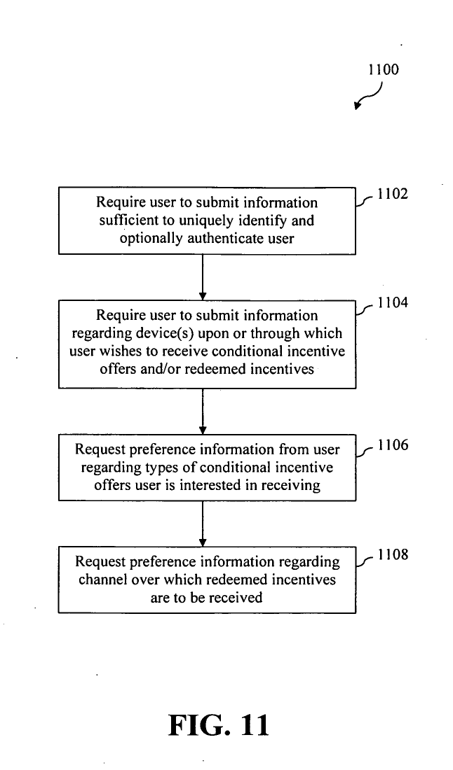

User registration and account management interface 1002 is configured to allow a user to register to receive conditional incentive offers from conditional incentive engine 102 and to manage certain aspects related to the receipt, tracking and redemption of conditional incentive offers. In one implementation, user registration and account management interface 1002 is configured to require a user to complete a registration process in order to receive conditional incentive offers. FIG. 11 depicts a flowchart 1100 of an example registration process that may be implemented by user registration and account management interface 1002 in accordance with one embodiment of the present invention.

As shown in FIG. 11, the registration process includes a step 1102 during which user registration and account management interface 1102 requires a user to submit information sufficient to uniquely identify the user. The information sufficient to uniquely identify the user may comprise, for example, a unique user name, e-mail address, or the like.

During step 1102, user registration and account management interface 1002 may also optionally require the user to provide user authentication information. As will be discussed in more detail herein, such user authentication information may be used by conditional incentive engine 102 to determine whether a condition associated with a particular incentive has been fulfilled by the appropriate user or users. The type of user authentication information that may optionally be provided in step 1102 may depend on the type of user authentication logic used by conditional incentive engine 102. Such information may include, for example, personal login information such as a user password or passkey or biometric information such as user fingerprint scan, retinal scan, facial image or speech sample.

During step 1104, user registration and account management interface 1002 requires a user to submit information concerning one or more devices upon or through which the user wishes to receive conditional incentive offers and/or redeemed incentives. This information may include for example, a unique identifier of each device. In an embodiment, user registration and account management interface 1002 automatically obtains such information from a user device that is communicatively coupled thereto. Depending upon the implementation, eligible devices may include but are not limited to portable electronic devices such as cellular phones, personal digital assistants, portable media players, laptop computers and tablet computers as well as more stationary electronic devices such as desktop computers, gaming consoles, set top boxes, or the like.

During step 1106, user registration and account management interface 1002 requests preference information from the user regarding types of conditional incentive offers the user is interested in receiving. In an embodiment, such preference information may be provided during the registration process or at any time thereafter. By providing such preference information, a user may elect to receive conditional incentive offers involving specific products or services or certain types of products and services. A user may also elect to receive conditional incentive offers that originate from a particular sponsor, that are associated with a particular campaign, or that are of a certain type and/or magnitude (e.g., discount coupons from sporting goods stores of over $10 in value). A user may also elect to receive conditional incentive offers based on the type of conditions involved in achieving redemption of an incentive (e.g., a user may elect to receive all conditional incentive offers that require long-distance running or recycling to redeem the incentive). A user may also elect to receive conditional incentive offers that have been selected for participation, recommended, and/or redeemed by other users with whom the user shares some commonality, such as belonging to the same social network or user demographic.

During step 1108, user registration and account management interface 1002 requests preference information from the user regarding a channel over which the user wishes to receive redeemed conditional incentives. This step would only be implemented in an embodiment in which a conditional incentive may be redeemed via a plurality of different redemption channels. In an embodiment, such preference information may be provided during the registration process or at any time thereafter. Where a redeemed incentive may be received in electronic form (such as a unique digital coupon), the redemption channels may include any channel over which electronic information may be communicated to a user such as, for example, an e-mail or SMS message to one or more registered user devices. Where a redeemed incentive may be received in printed form, the redemption channels may include for example, regular mail or facsimile. Incentives may also be received in a variety of other forms via a variety of other channels, such as in the form of a credit to a user account managed by a third party (such as a credit to a credit card account or frequent flyer miles account) or via the immediate or subsequent delivery or provision to the user of an actual product or service.

In a further embodiment, a user may specify that redeemed conditional incentives should be delivered to one or more other users or one or more other entities in addition to or instead of the user himself/herself. By way of example, a user may specify that redeemed conditional incentives should be delivered to a family member, friend, or charity.

The foregoing registration process of flowchart 1100 has been described herein by way of example only. Persons skilled in the relevant art(s) will appreciate that alternate registration processes may be used to implement various embodiments of the present invention. Furthermore, in some implementations, no user registration process is required. In such implementations, users may receive conditional incentive offers from sponsors and redeem conditional incentives when appropriate via one or more pre-existing communication channels.

User registration and account management interface 902 may be configured to obtain preference information from users beyond that described in reference to steps 1106 and 1108 of flowchart 1100. For example, a user may specify a minimum and/or maximum amount of conditional incentive offers he/she wishes to receive or a frequency with which he/she wishes to receive such offers. Furthermore, a user may provide preference information regarding types of conditional incentive offers he/she does not wish to receive for whatever reason. A user may also specify privacy conditions regarding how data about the user is obtained or tracked by conditional incentive engine 102 and/or network-based tracking engine 108. In still another example, a user may designate temporal, spatial, social and/or topical parameters relating to the receipt of conditional incentive offers. For example, a user may specify a time period or a location at which he/she wishes to receive conditional incentive offers. These examples of user preferences are provided by way of illustration only, and persons skilled in the relevant art(s) will appreciate that various other user preferences may be specified by a user in regard to the receipt and redemption of conditional incentive offers.

b. Conditional Incentive Receipt and Tracking Interface

Conditional incentive receipt and tracking interface 1004 is configured to provide an interface by which a user can receive conditional incentive offers, selectively participate in certain conditional incentive offers, and track progress towards fulfillment of the conditions associated with such selected conditional incentive offers.

In one embodiment, conditional incentive receipt and tracking interface 1004 comprises a graphical user interface (GUI) that allows a user to view received conditional incentive offers and to selectively elect to participate in such offers. Election to participate in an offer indicates that a user wishes to attempt to fulfill the condition(s) associated with the conditional incentive offer in order to redeem the associated incentive. In an embodiment, conditional incentive receipt and tracking interface 1004 maintains a list of offers in which a user is currently participating and a user may selectively delete and/or terminate participation in any offer in the list at any time. Offers may be organized by sponsor, campaign, or in some other fashion.

Conditional incentive receipt and tracking interface 1004 may be further configured to present a user with a list of the conditions that must be fulfilled in order to redeem a conditional incentive offer. Conditional incentive receipt and tracking interface 1004 may further indicate which of the conditions associated with an offer have already been fulfilled by the user. This beneficially enables a user to track his/her progress towards redemption of an incentive. Conditional incentive receipt and tracking interface 1004 may further provide a user with information about incentives that have already been redeemed by the user.

c. Conditional Incentive Redemption Interface

Conditional incentive redemption interface 1006 is configured to provide an interface by which a user may initiate redemption of an incentive when all the redemption conditions associated with the incentive have been fulfilled. In an alternate embodiment, no redemption interface 1006 is provided and an incentive is automatically delivered to a user upon fulfillment of all of the requisite conditions associated therewith. Alternatively, redemption may be triggered by a sponsor through interaction with sponsor interface 906.

2. User Information Database

User information database 904 is configured to store data associated with users of conditional incentive engine 102. Although user information database 904 is shown as a single database in FIG. 9, it is to be understood that depending on volume and/or other factors, the user information may be stored in numerous databases. Such databases may be managed by numerous database servers in communication with conditional incentive engine 102.

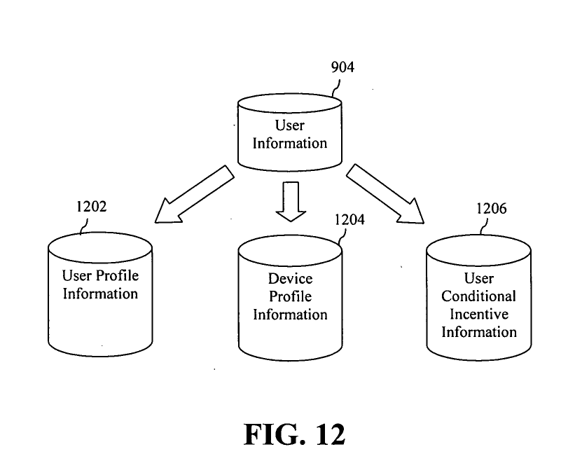

As shown in FIG. 12, the user information stored in user information database 904 may comprise at least three different types of user information namely, user profile information 1202, device profile information 1204, and user conditional incentive information 1206. Each of these types of user information will now be briefly described.

User profile information 1202 includes information that uniquely identifies and optionally authenticates each user of conditional incentive engine 102. Such information may be provided during a user registration process as previously described in reference to FIG. 11. User profile information 1202 may further include preference information provided by a user regarding types of conditional incentive offers the user is interested in receiving, regarding a redemption channel by which the user wishes to receive redeemed conditional incentives, and/or regarding other aspects associated with the receipt, tracking and redemption of conditional incentives as discussed above in reference to user registration and account management interface 1002 of FIG. 10. User profile information 1202 may further include system-derived information about a user, such as demographic information about a user, social network information, historical information about a user's activities or behaviors, or the like. Such system-derived information may be obtained, for example, from network-based tracking engine 108 or from a third-party system.

Device profile information 1204 includes information that uniquely identifies each device registered by a user for the receipt, tracking and/or redemption of conditional incentives. Such information may be provided or obtained during a user registration process as previously described in reference to FIG. 11. Device profile information 1204 may further include information associated with each registered device that is used by user interface 902 to determine how and in what form conditional incentives and related information should be delivered to the device. Such information may include device-specific preferences provided by user, a device type, device hardware or software versions, a network connection type, device memory capacity, or the like. Such information may also be used by incentive matching manager 910 to determine whether certain conditional incentives can be delivered to certain registered devices.

User conditional incentive information 1206 includes information relating to all conditional incentives received, selected for participation, deleted, or redeemed by a user. For example, such information may include, but is not limited to, a unique identifier associated with each conditional incentive, an identifier of a campaign with which the conditional incentive is associated, descriptive information concerning the conditions associated with the conditional incentive, descriptive information concerning the incentive associated with the conditional incentive, an indication of whether each condition associated with the conditional incentive has been fulfilled by the user or not, and/or a status of the conditional incentive (e.g., pending, participating, redeemed, deleted). Various aspects of this information may be presented to a user as discussed above in reference to user interface 902.

3. Sponsor Interface

Sponsor interface 906 is a component that is configured to allow sponsors 106 to interact with conditional incentive engine 102 for the purpose of creating or otherwise providing conditional incentive offers for presentation to users 104, specifying targeting criteria for matching such offers to certain users or user populations, tracking the progress of users towards fulfillment of the conditions associated with the redemption of a conditional incentive, and initiating or effecting delivery of an incentive to a user upon fulfillment of such redemption conditions. In one embodiment, sponsor interface 906 is implemented using a Web service and a standard set of Web APIs for utilizing the Web service. Web applications built upon the Web service may be published by an entity that owns and/or operates conditional incentive engine 102 or by other entities. Such Web applications are accessed by users using Web browsers in a well-known fashion. However, this is only one example, and sponsor interface 906 may be implemented in other ways.

Any of a wide variety of sponsor systems/devices may be used to interact with sponsor interface 906, including but not limited to electronic systems/devices having wired or wireless network communication functionality. In one embodiment, communication between sponsors and sponsor interface 906 occurs over the Internet. However, the invention is not so limited, and communication between sponsors and sponsor interface 902 may occur over any type of network or combination of networks including wide area networks, local area networks, private networks, public networks, packet networks, circuit-switched networks, and wired or wireless networks.

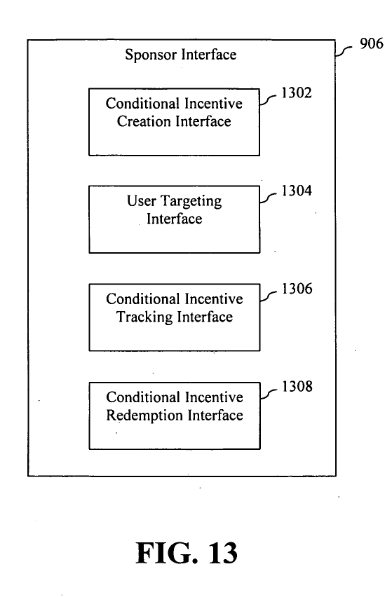

As shown in FIG. 13, in one embodiment, sponsor interface 906 comprises at least four distinct sponsor interface components—namely, a conditional incentive creation interface 1302, a user targeting interface 1304, a conditional incentive tracking interface 1306 and a conditional incentive redemption interface 1308. Each of these different interface components will now be described.

a. Conditional Incentive Creation Interface

Conditional incentive creation interface 1302 is configured to allow a sponsor to create conditional incentive offers for storage and subsequent presentation to users of conditional incentive engine 102. In one implementation, each conditional incentive offer so created is associated with at least one conditional incentive campaign, although the invention is not so limited. At a minimum, the terms of each conditional incentive offer include an incentive and one or more conditions that must be fulfilled by a user in order to redeem the incentive.

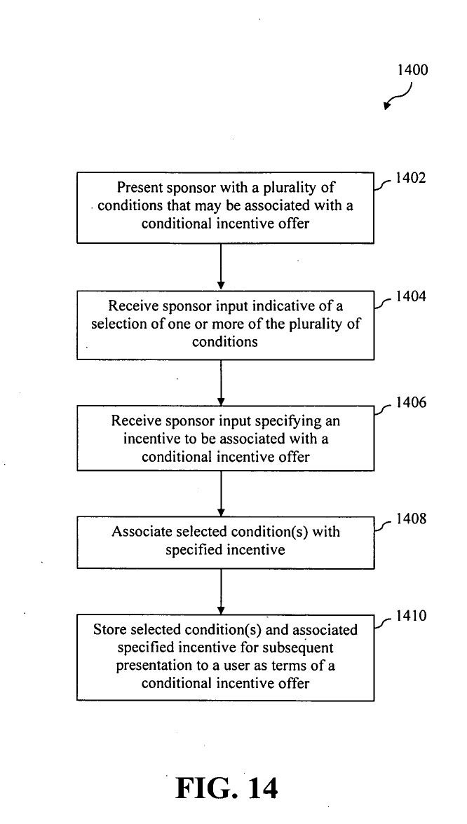

FIG. 14 depicts a flowchart 1400 of a method by which conditional incentive creation interface 1302 facilitates creation of a conditional incentive offer for presentation to a user. As shown in FIG. 14, the method of flowchart 1400 begins at step 1402 in which conditional incentive creation interface 1302 presents a sponsor with a plurality of conditions that may be associated with a conditional incentive offer. In an embodiment, the fulfillment of each condition so presented may be automatically determined by conditional incentive engine 102 based on spatial, temporal, social and/or topical data associated with a user that is obtained from a network-based tracking engine and/or by information provided by a participating user via user interface 902.

For example, the conditions presented during step 1402 may include location-related conditions (e.g., conditions that require a user to travel to a certain location or perform an activity or observe certain behaviors at a particular location), temporal conditions (e.g., conditions that require a user to perform activities or observe certain behaviors at certain times, within certain time frames, or at a particular temporal frequency), social conditions (e.g., conditions that require a user to perform activities that involve a certain number of social relations), or topical conditions (e.g., conditions that require a user to perform activities in relation to certain subject matter, such as in relation to certain objects or events). The fulfillment of each of these conditions by a particular user may be determined based on spatial, temporal, social and/or topical data associated with the user that is obtained from network-based tracking engine 108.

Fulfillment of the conditions presented during step 1402 may also require input to be received from one or more users via user interface 902. For example, a condition may require that one or more users verify their identity to conditional incentive engine 102. In such an embodiment, the user(s) may provide user authentication information via user interface 902 so that the verification may be performed. As noted elsewhere herein, such user authentication information may include for example a personal password or passkey or biometric information such as a fingerprint scan, retinal scan, facial image or speech sample.

At step 1404, conditional incentive creation interface 1302 receives input from the sponsor that is indicative of a selection of one or more of the plurality of conditions previously presented to the sponsor during step 1402. This step may further include receiving input from the sponsor that specifies certain parameters associated with each selected condition(s). For example, if one of the selected conditions is performance of an activity within a particular time frame, the sponsor may specify the time frame. As another example, if one of the selected conditions is performance of an activity at a particular location, the sponsor may specify the location. These are but only a few examples and persons skilled in the relevant art will appreciate that a wide variety of other parameters may be specified with respect to a selected condition.

At step 1406, conditional incentive creation interface 1302 receives input from the sponsor that specifies an incentive to be associated with a conditional incentive offer. The incentive may comprise, for example, a monetary incentive such as a cash reward, a discount or a rebate on a product or service. The incentive may also comprise non-monetary incentives, such as some form of public or private recognition (e.g., a publicly or privately-received award). Such incentives may further include the avoidance of penalties or punishments (e.g., fines) resulting from non-fulfillment of certain associated conditions. As noted elsewhere herein, the incentive may accrue to a user and/or to various third parties who may or may not be associated with the user (e.g., family members, friends, a charity, etc.).

In one implementation, the sponsor specifies the incentive by selecting an incentive type from among a plurality of incentive types presented to the sponsor by conditional incentive creation interface 1302 and by then providing certain parameters associated with the selected incentive type via conditional incentive creation interface 1302. For example, the sponsor may specify an incentive by selecting a coupon type incentive from among a plurality of incentive types and by then submitting an amount to be associated with the coupon.

At step 1408, conditional incentive creation interface 1302 associates the condition(s) selected by the sponsor as determined during step 1404 with the incentive specified by the sponsor as determined during step 1406. At step 1410, conditional incentive creation interface 1302 stores the selected condition(s) and associated specified incentive in a database for subsequent presentation to a user as terms of a conditional incentive offer. The selected condition(s) and associated specified incentive may be stored, for example, in sponsor information database 908 which will be described in more detail below.

Other information associated with a conditional incentive offer that may be provided by a sponsor via conditional incentive creation interface 1302 may include a title of a campaign associated with the conditional incentive offer and media assets (e.g., text, graphics, audio and or video assets) associated with presentation of the conditional incentive offer.

b. User Targeting Interface

User targeting interface 1304 is configured to allow a sponsor to specify users or types of users that should be targeted for receiving conditional incentive offers. For example, user targeting interface 1304 may allow a sponsor to specify certain prerequisites that a user must satisfy in order to receive a conditional incentive offer. Such prerequisites may include, for example, registration by the user of a device suitable for receiving an offer. User targeting interface 1304 may also allow a sponsor to specify certain user demographics that should be targeted for receipt of a conditional incentive offer. User targeting interface 1304 may further allow a sponsor to specify certain user profile types that should receive conditional incentive offers or certain historical behaviors or activities that should cause a conditional incentive offer to be pushed to a user.

c. Conditional Incentive Tracking Interface

Conditional incentive tracking interface 1306 is configured to allow a sponsor to track the acceptance, deletion, progress towards fulfillment and redemption of conditional incentives delivered to users of conditional incentive engine 102. Depending upon the implementation, such information may be tracked and presented to the sponsor at the level of all users that have received a conditional incentive offer, at the level of various sub-groups of users that have received the conditional incentive offer, and/or at the level of each individual that has received the conditional incentive offer. Such information may beneficially allow a sponsor to accurately measure user response to a particular conditional incentive based campaign. For example, a sponsor may accurately determine what percentage of users receiving the conditional incentive offer accepted the offer or deleted it. As another example, a sponsor may accurately determine the redemption rate associated with a particular offer.

d. Conditional Incentive Redemption Interface

Conditional incentive redemption interface 1308 is configured to provide an interface by which a sponsor may initiate redemption of an incentive when all the redemption conditions associated with the incentive have been fulfilled by a user. In an alternate embodiment, no redemption interface 1308 is provided and an incentive is automatically delivered to a user upon fulfillment of all of the requisite conditions associated therewith. Alternatively, redemption may be triggered by a user through interaction with user interface 902.

4. Sponsor Information Database

Sponsor information database 908 is configured to store data associated with sponsors of conditional incentive offers distributed via conditional incentive engine 102. Although sponsor information database 908 is shown as a single database in FIG. 9, it is to be understood that depending on volume and/or other factors, the sponsor information may be stored in numerous databases. Such databases may be managed by numerous database servers in communication with conditional incentive engine 102.

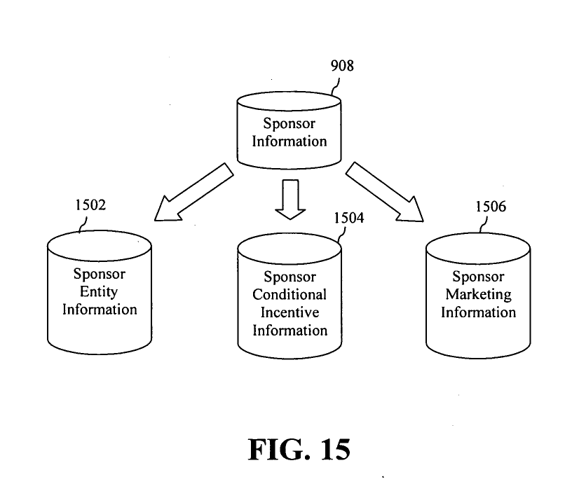

As shown in FIG. 15, the sponsor information stored in sponsor information database 908 may comprise at least three different types of sponsor information-namely, sponsor entity information 1502, sponsor conditional incentive information 1504, and sponsor marketing information 1506. Each of these types of sponsor information will now be briefly described.

Sponsor entity information 1502 includes information about each sponsor that has registered to use conditional incentive engine 102 for the distribution of conditional incentives. Sponsor entity information 1502 may include, for example, information such as organization name, address, city, state, zip code, country, telephone number, facsimile number, tax ID (SSN/EIN), tax classification, and/or VAT number. Furthermore, sponsor entity information 1502 may also include information about a contact person, wherein such information may include the contact person's first and last name, title/function within the organization, telephone number and e-mail address.

Sponsor conditional incentive information 1504 includes information concerning all conditional incentive offers currently being sponsored by sponsors 106 for distribution via conditional incentive engine 102. Such information may include, for example, identification of a campaign associated with a conditional incentive offer, terms of a conditional incentive offer (including an incentive and one or more conditions that must be fulfilled by a user or users in order to redeem the incentive), media assets (e.g., text, graphics, audio and or video assets) to be used during presentation of conditional incentive offer, or the like.

For each sponsor, sponsor conditional incentive information 1504 may further include information concerning the acceptance, deletion, progress towards fulfillment and redemption of each sponsored conditional incentive offer that has been delivered to a user of conditional incentive engine 102. As noted above with respect to sponsor interface 906, such information may be tracked at the level of all users that have received a conditional incentive offer, at the level of various sub-groups of users that have received the conditional incentive offer, and/or at the level of each individual that has received the conditional incentive offer.

Sponsor marketing information 1506 includes information related to campaigns with which one or more conditional incentives may be associated. Such campaign information may include, for example, certain commercial or non-commercial goals associated with a campaign or various terms that should be associated with conditional incentive offers associated with the campaign. Sponsor marketing information 1506 may also include targeting information associated with one or more conditional incentives or with a campaign. As noted above, such targeting information may include but is not limited to an identification of a particular demographic to which the conditional incentive offers should be directed, an identification of certain user profile types that should receive conditional incentive offers, or a specification of certain historical behaviors or activities on the part of a user that should cause a conditional incentive offer to be presented to the user.

5. Incentive Matching Manager

Incentive matching manager 910 is a component that is configured to selectively present active conditional incentive offers to users of conditional incentive engine. Incentive matching manager 910 is configured to obtain information about active conditional incentive offers from sponsor information database 908 and to selectively present such offers to users for display on their respective systems/devices via user interface 902.

In an embodiment, incentive matching manager 910 selectively presents certain conditional incentive offers to certain users based on predefined matching criteria. The matching criteria may include, for example, certain prerequisites that a user must satisfy in order to receive a particular conditional incentive offer. These prerequisites may be associated with a conditional incentive offer or a campaign, and information concerning such prerequisites may be stored in sponsor information database 908. Such prerequisites may include, for example, registration by a user of a device suitable for receiving an offer.

The matching criteria may also include targeting information that is provided by a sponsor and stored in sponsor information database 908. As noted above, such targeting information may include, for example, an identification of a particular demographic to which a conditional incentive offer should be directed, an identification of certain user profile types that should receive a conditional incentive offer, or a specification of certain historical behaviors or activities on the part of a user that should cause a conditional incentive offer to be presented to the user. For example, incentive matching manager 910 may correlate such targeting information with information about a user that is stored in user information database 904, that is obtained from network-based tracking engine 108, or that is obtained from a third-party system to determine whether certain conditional incentive offers should be presented to the user.

The matching criteria may further include various user preferences, information about which may be obtained from user information database 904. Such user preferences may include preferences concerning the types of conditional incentive offers that a user wishes or does not wish to receive, a minimum and/or maximum amount of conditional incentive offers that the user wishes to receive, and/or a frequency with which the user wishes to receive such offers. Such user preferences may also include temporal, spatial, social and/or topical contexts within which a user may wish to receive or not receive conditional incentive offers. For example, a user may prefer to receive conditional incentive offers during a particular time period or at a particular location only, or may prefer to receive only conditional incentive offers that have previously been selected for participation, recommended or redeemed by members of his/her social network.

When incentive matching manager 910 has determined that a conditional incentive offer is to be presented to a particular user, it effects such presentation by forwarding the information necessary for presentation of the offer to user interface 902. User interface 902 then performs operations to display the offer to the user via one or more registered user systems/devices 104 associated with the user. Incentive matching manager 910 also creates an entry in user information database 904 that reflects that a unique instance of the conditional incentive offer has been presented to the user. This entry is then maintained by condition tracking manager 912, which tracks any subsequent activities or status changes that occur in relation to the instance of the offer. A corresponding entry may also be created in sponsor information database 908 for tracking purposes.

6. Condition Tracking Manager

Condition tracking manager 912 is a component that is configured to automatically determine whether a user that is participating in a conditional incentive offer has fulfilled each of the requisite condition(s) for redemption of the conditional incentive offer and to generate a notification to sponsors 106 and/or users 104 when all of the requisite conditions have been fulfilled.

To perform this function, condition tracking manager 912 is configured to access user information database 904 to identify conditional incentive offers that have been received by and selected for participation by users of conditional incentive engine 102. For each conditional incentive offer so identified, condition tracking manager 912 is further configured to determine whether each currently unfulfilled condition associated with the offer has been fulfilled. Depending upon the implementation, condition tracking manager 912 may make this determination on a periodic basis, when new information about the user is received via network-based tracking engine 108 or user interface 902, and/or based on prompting by a user via user interface 902 or a sponsor via sponsor interface 906.

The determination by condition tracking manager 912 as to whether a currently unfulfilled condition associated with a conditional incentive has been fulfilled by a user may be made based on information obtained about the user from network-based tracking engine 108 and/or based on information obtained directly from the user via user interface 902. The former type of information may be thought of as “implicit” user information while the latter type of information may be thought of as “explicit” user information.

With respect to implicit user information, network-based tracking engine 108 is capable of obtaining and providing highly granular spatial, temporal social and topical information about a user as described in detail above. Condition tracking manager 912 is advantageously configured to utilize such information to determine when a user has satisfied one or more conditions associated with a conditional incentive offer.

For example, condition tracking manager 912 may utilize spatial information associated with a user that is tracked by network-based tracking engine 108 to determine whether a condition associated with a conditional incentive offer has been fulfilled by the user. For instance, condition tracking manager 912 may obtain spatial information associated with the user from network-based tracking engine 108 to determine whether or not the user has travelled to a certain location or performed an activity or observed certain behaviors at a particular location. Condition tracking manager 912 may also use such spatial information to determine whether a user is co-located with respect to a particular individual or individuals.

As a further example, conditional tracking manager 912 may utilize temporal information associated with a user that is tracked by network-based tracking engine 108 to determine whether a condition associated with a conditional incentive offer has been fulfilled by the user. For instance, condition tracking manager 912 may obtain temporal information associated with the user to determine whether or not the user has performed activities or observed certain behaviors at certain times, within certain time frames, or at a particular temporal frequency.

As a still further example, conditional tracking manger 912 may utilize social information associated with a user that is tracked by network-based tracking engine 108 to determine whether a condition associated with a conditional incentive offer has been fulfilled by the user. For instance, condition tracking manager 912 may obtain social information associated with the user to determine whether or not the user has performed an activity that involves a certain number of social relations.

As yet another example, conditional tracking manager 912 may utilize topical information associated with a user that is tracked by network-based tracking engine 108 to determine whether a condition associated with a conditional incentive offer has been fulfilled by the user. For instance, condition tracking manager 912 may obtain topical information associated with the user to determine whether or not the user has performed an activity in relation to certain subject matter, such as in relation to certain objects or events.

As noted above, explicit user information may be provided by a user via user interface 902 and used by condition tracking manager 912 to determine whether or not a condition associated with a conditional incentive offer has been fulfilled. Such information may include, for example, user authentication information that is used by condition tracking manager 912 to verify the identity of one or more users participating in a conditional incentive offer. Such user authentication information may include, for example, a personal password or passkey or biometric information such as a fingerprint scan, retinal scan, facial image or speech sample. Such explicit user information may also include information that could only be known to the user if the user had performed a certain activity or completed a certain task.

If condition tracking manager 912 determines that a participating user has fulfilled a condition associated with a conditional incentive offer, condition tracking manager 912 modifies an entry corresponding to the appropriate conditional incentive offer in user information database 904 to indicate that the particular condition has been fulfilled. User interface 902 may then report fulfillment of the condition to the user. Condition tracking manager 912 may also modify an entry corresponding to the appropriate conditional incentive offer in sponsor information database 908 to reflect the fulfillment of the condition. This permits conditional incentive tracking functionality of sponsor interface 906 to report or otherwise take account of the event.

If condition tracking manager 912 determines that a participating user has fulfilled all of the conditions associated with a conditional incentive offer, condition tracking manager 912 modifies an entry corresponding to the appropriate conditional incentive offer in user information database 904 to indicate that all conditions required for redemption have been fulfilled. User interface 902 may then report this event to the user and, depending upon the implementation, the user may initiate redemption of the incentive via user interface 902. Condition tracking manager 912 may also modify an entry corresponding to the appropriate conditional incentive offer in sponsor information database 908 for reporting to the sponsor of the offer. Depending upon the implementation, the sponsor may initiate delivery of the incentive to the user via interface 906.

In a further embodiment, condition tracking manager 912 sends a notification to redemption manager 914 when it has determined that a participating user has fulfilled all of the conditions associated with a conditional incentive offer and, responsive to receiving the notification, redemption manager 914 automatically initiates redemption and delivery of the appropriate incentive from a sponsor to a user.

7. Redemption Manager

Redemption manager 914 is a component that is configured to facilitate the transfer of redeemed incentives from sponsors 106 to users 104. In one embodiment, redemption manager 914 provides a channel for delivery of incentives in electronic form (e.g., unique digital coupons) from a system associated with sponsors 106 to one or more registered systems/devices associated with a user 104.

In a further embodiment, redemption manager 914 is configured to initiate other mechanisms by which a redeemed incentive may be delivered from a sponsor 106 to a user 104. For example, redemption manager 914 may be configured to trigger the mailing or facsimile of an incentive to a user in printed form. Redemption manager 914 may also be configured to communicate with third party systems to facilitate delivery of an incentive. For example, redemption manager 914 may communicate with a third party system to cause a credit to be added to an account associated with the user that is managed by the third party or to cause the immediate or subsequent delivery or provision by the third party to the user of an actual product or service.

Depending upon the implementation, redemption manager 914 may be configured to perform activities related to the delivery of a redeemed incentive based on a notification from conditional incentive redemption interface 1006 of user interface 902 that a user has initiated redemption, a notification from conditional incentive redemption interface 1308 of sponsor interface 906 that a sponsor has initiated redemption, or based on a notification from condition tracking manager 912 that the conditions associated with redemption of a particular conditional incentive offer have been fulfilled.

### III. Example Method for Conditional Incentive Presentation, Tracking and Redemption

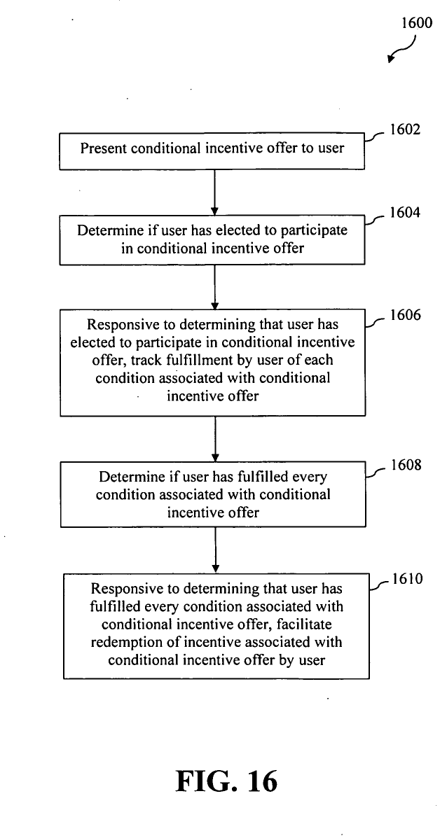

An example method for presenting, tracking and redeeming a conditional incentive in accordance with an embodiment of the present invention will now be described with reference to flowchart 1600 of FIG. 16. Such a method may advantageously be used to incentivize performance of an activity or observance of a behavior by a user or a group of users. The method will be described with continued reference to system 100 of FIG. 1, although the method is not limited to that implementation.

As shown in FIG. 16, the method of flowchart 1600 begins at step 1602 in which user interface 902 of conditional incentive engine 102 presents a conditional incentive offer to a user. The terms of the conditional incentive offer comprise an incentive and at least one condition to be fulfilled by the user to redeem the incentive. A condition may comprise, for example, an activity to be performed by the user or a behavior to be observed by the user. In an embodiment, the conditional incentive offer is presented to a display interface (e.g., a monitor or screen) or other interface of a registered user system/device for viewing and selective participation by the user. The conditional incentive offer may be presented using text, graphics, audio and/or video content. As discussed elsewhere herein, the conditional incentive offer may be selected for presentation to the user based on a matching function performed by incentive matching manager 910 of conditional incentive engine 102.

At step 1604, condition tracking manager 912 of conditional incentive engine 102 determines if the user has elected to participate in the conditional incentive offer. Depending upon the implementation, condition tracking manager 912 may determine that the user has elected to participate in the conditional incentive offer based on a notification from user interface 902 or based on the modification by user interface 902 of an entry associated with the conditional incentive offer in user information database 904. User interface 902 may generate such a notification or modify such an entry based on input received from the user indicating that the user wishes to participate in the conditional incentive offer. In an alternate embodiment, condition tracking manager 912 determines that a user has elected to participate in the conditional incentive offer by determining that the user has fulfilled one or more of the conditions associated with the conditional incentive offer.

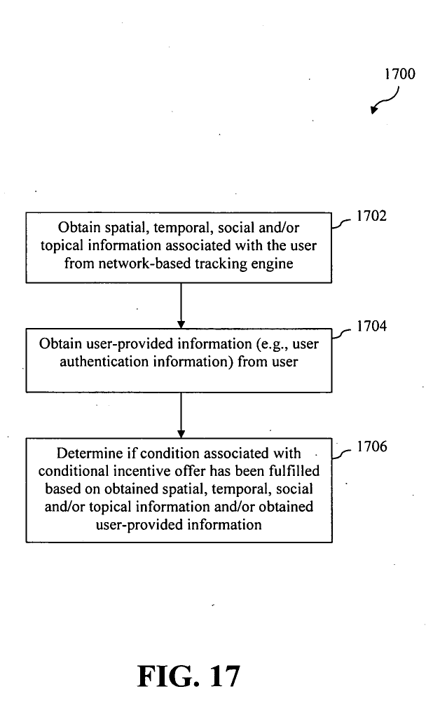

At step 1606, responsive to determining that the user has elected to participate in the conditional incentive offer, condition tracking manager 912 of conditional incentive engine 102 tracks fulfillment by the user of each condition associated with the conditional incentive offer. One manner by which condition tracking manager 912 may perform this function will be described below in reference to flowchart 1700 of FIG. 17.

At step 1608, condition tracking manager 912 determines if the user has fulfilled every condition associated the conditional incentive offer.

At step 1610, responsive to a determination by condition tracking manager 912 that the user has fulfilled every condition associated with the conditional incentive offer, redemption manager 914 of conditional incentive engine 102 facilitates redemption of the incentive associate with the conditional incentive offer by the user. Condition tracking manager 912 may notify redemption manager 914 when all the conditions have been fulfilled or, alternatively, condition tracking manager 912 may notify the user via user interface 902 or a sponsor of the conditional incentive offer via sponsor interface 906 and the user or sponsor may in turn initiate performance of the redemption function by redemption manager 914.

As noted above, in one embodiment, redemption manager 914 facilitates redemption of the incentive by providing a channel for delivery of digital incentives from a system associated with a sponsor to one or more registered systems/devices associated with the user. Redemption manager 914 may also facilitate redemption in other ways, such as by triggering the mailing or facsimile of an incentive to a user in printed form or by communicating with a third party system to facilitate delivery of an incentive.

FIG. 17 depicts a flowchart of one method by which condition tracking manager 912 may determine whether a condition associated with a conditional incentive offer has been fulfilled by a user in accordance with an embodiment of the present invention. As shown in FIG. 17, the method begins at step 1702 in which condition tracking manager 912 obtains spatial, temporal, social and/or topical information associated with the user from network-based tracking engine 108.

At step 1704, condition tracking manager 912 optionally obtains user-provided information from the user via user interface 902. As previously discussed herein, the user-provided information may include, for example, user authentication information that can be used by condition tracking manager 912 to verify the identity of one or more users participating in a conditional incentive offer.

At step 1706, condition tracking manager 912 determines if the condition associated with the conditional incentive offer has been fulfilled by the user based on the obtained spatial, temporal, social and/or topical information and/or the obtained user-provided information.

Various examples of different types of conditional incentive offers that may be presented, tracked and redeemed in accordance with the foregoing methods of flowcharts 1600 and 1700 will now be described in order to further illustrate the features and advantages of various embodiments of the present invention.

For example, a conditional incentive based campaign in accordance with one embodiment of the present invention is designed to encourage users to speak softly when using BLUETOOTH communication devices, such as BLUETOOTH wireless headsets, or other wireless mobile communication devices. Such a campaign may be sponsored by various public and/or private entities to reduce noise and associated disruption. In accordance with this example, the offered incentive may be a reward for compliance with a prescribed decibel level limit on the user's speech when using BLUETOOTH devices or the avoidance of fines or some other penalty for non-compliance. For each participating user, network-based tracking engine 108 will monitor the speech signals input to one or more BLUETOOTH devices associated with the user to determine when such speech signals exceed the predefined decibel level limit and to record times and/or locations when such transgressions occur. Condition tracking manager 912 within conditional incentive engine 102 will then receive such information to determine whether each participating user is in compliance with the decibel level limit or not and to periodically award rewards or fines as appropriate. To limit enforcement of the campaign to only certain areas or times, the prescribed decibel level limit may only be monitored when the user is in a particular location and/or at particular times as tracked by network-based tracking engine 108.

Another example conditional incentive campaign in accordance with an embodiment of the present invention seeks to encourage users to bring a certain number of customers to a particular restaurant on a particular day of the week at a particular time, thereby increasing patronage. In accordance with this example, the offered incentive may be a discount coupon that may be used to purchase menu items at the restaurant or some other reward. To ensure that a user has complied with the redemption conditions, condition tracking manager 912 obtains spatial and temporal data associated with the user obtained from network-based tracking engine 108 to determine that the user is at the restaurant at the appointed time. Condition tracking manager 912 also performs an identity verification test on the remaining members of the party to ensure that the requisite number of customers have accompanied the user. Such identity verification may be performed by confirming that mobile devices registered to the remaining party members are co-located with the user or by processing authentication information provided via one or more devices registered to members of the party to verify the identities of the party members. As noted elsewhere herein, such authentication information may include but is not limited to personal login information such as a user password or passkey or biometric information such as user fingerprint scan, retinal scan, facial image or speech sample. Once condition tracking manager 912 has confirmed that the necessary redemption conditions have been met, redemption manager 914 of conditional incentive engine 102 may cause the coupon to be issued to the user via a preferred redemption channel as selected by the user.

A further example of a conditional incentive campaign in accordance with an embodiment of the present invention encourages users to conserve energy and reduce greenhouse gas emissions by carpooling. In accordance with this example, the offered incentive may be a free tune up for the user's car and the redemption conditions may include logging ten carpooling trips with two or more other registered carpoolers. In further accordance with this example, each carpooler registers with conditional incentive engine 102. Condition tracking manager 912 then logs each carpooling trip by monitoring implicit data obtained from network-based tracking engine 108 and explicit data obtained from the user and/or the other carpoolers. The implicit data may include spatial and temporal information that can be used to determine whether the user is in a car and is co-located with the other carpoolers. The explicit data may comprise user authentication information that can be used to verify the identity of the carpoolers. Once ten carpool trips have been logged, redemption manager 914 operates to ensure that the appropriate reward is issued. Depending upon how the campaign is implemented, the reward can accrue to a single user only or to all of the carpoolers, since they are all registered with conditional incentive engine 102.

Depending upon the implementation, an incentive based campaign in accordance with an embodiment of the present invention may be implemented on behalf of more than one entity. For example, an incentive based campaign may be implemented on behalf of more than one advertiser. In accordance with this example, a restaurant and movie theater located in the same shopping center could sponsor a co-branded incentive conditioned on visiting both the restaurant and the movie theater in a single evening. In further accordance with this example, a provider of satellite radio service could offer a number of months of free service if a users buys a car equipped to receive such service from a particular automotive manufacturer or dealership.

Incentive based campaigns may also be directed to groups of users, with only a subset of the users actually receiving the proffered incentive depending on which users satisfy the conditions associated with the campaign first or depending on some other measurable aspect of user performance of the conditions. Thus, games, contests and competitions may be supported.

These are only a few examples and numerous other campaigns may be designed in accordance with various embodiments of the present invention to encourage or discourage a wide variety of user actions and behaviors. Embodiments of the present invention may advantageously be used not only by commercial entities, but also governmental entities, community groups, charitable organizations, or any other entity or organization seeking to encourage or discourage certain user behaviors or actions. For example, an embodiment of the present invention could be used to track compliance with court orders or other legally or judicially dictated rules or codes of conduct. The actions or behaviors that may be incentivized by an embodiment of the present invention may advantageously encompass any of a host of actions or behaviors that can be tracked by network-based tracking engine 108 previously described herein, including both “real world” actions and behaviors as well as online actions and behaviors.

### IV. Example Computer System Implementation

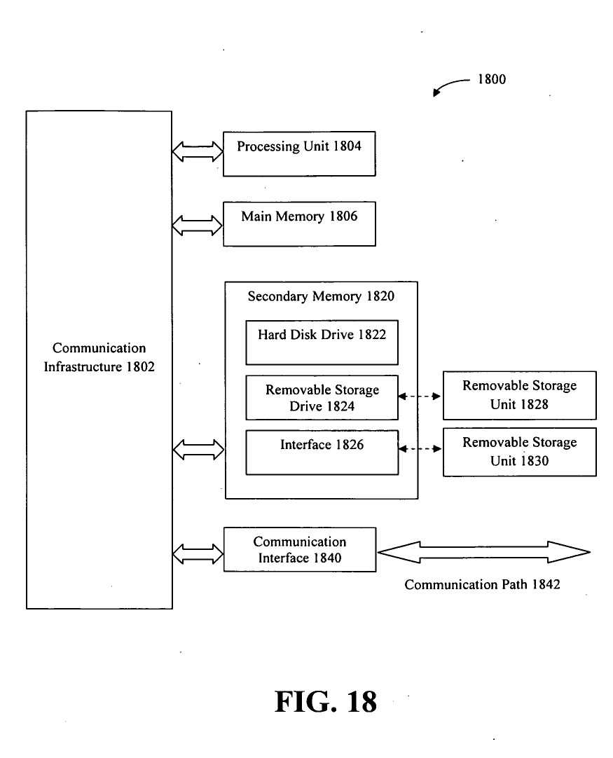

The embodiments described herein, including systems, methods/processes, and/or apparatuses, may be implemented using one or more processor-based computer systems, such as computer system 1800 shown in FIG. 18. For example, conditional incentive engine 102 or any components thereof, network-based tracking engine 108, W4 engine 410, W4 engine 602, W4 engine 702, or any of the methods of flowchart 1100, 1400, 1600 and 1700 can each be implemented using one or more computers systems 1800.

As shown in FIG. 18, computer system 1800 includes a processing unit 1804 that includes one or more processors. Processor unit 1804 is connected to a communication infrastructure 1802, which may comprise, for example, a bus or a network.

Computer system 1800 also includes a main memory 1806, preferably random access memory (RAM), and may also include a secondary memory 1820. Secondary memory 1820 may include, for example, a hard disk drive 1822, a removable storage drive 1824, and/or a memory stick. Removable storage drive 1824 may comprise a floppy disk drive, a magnetic tape drive, an optical disk drive, a flash memory, or the like. Removable storage drive 1824 reads from and/or writes to a removable storage unit 1828 in a well-known manner. Removable storage unit 1828 may comprise a floppy disk, magnetic tape, optical disk, or the like, which is read by and written to by removable storage drive 1824. As will be appreciated by persons skilled in the relevant art(s), removable storage unit 1828 includes a computer usable storage medium having stored therein computer software and/or data.

In alternative implementations, secondary memory 1820 may include other similar means for allowing computer programs or other instructions to be loaded into computer system 1800. Such means may include, for example, a removable storage unit 1830 and an interface 1826. Examples of such means may include a program cartridge and cartridge interface (such as that found in video game devices), a removable memory chip (such as an EPROM, or PROM) and associated socket, and other removable storage units 1830 and interfaces 1826 which allow software and data to be transferred from the removable storage unit 1830 to computer system 1800.

Computer system 1800 may also include a communication interface 1840. Communication interface 1840 allows software and data to be transferred between computer system 1800 and external devices. Examples of communication interface 1840 may include a modem, a network interface (such as an Ethernet card), a communications port, a PCMCIA slot and card, or the like. Software and data transferred via communication interface 1840 are in the form of signals which may be electronic, electromagnetic, optical, or other signals capable of being received by communication interface 1840. These signals are provided to communication interface 1840 via a communication path 1842. Communications path 1842 carries signals and may be implemented using wire or cable, fiber optics, a phone line, a cellular phone link, an RF link and other communications channels.

As used herein, the terms “computer program medium” and “computer readable medium” are used to generally refer to media such as removable storage unit 1828, removable storage unit 1830 and a hard disk installed in hard disk drive 1822. Computer program medium and computer readable medium can also refer to memories, such as main memory 1806 and secondary memory 1820, which can be semiconductor devices (e.g., DRAMs, etc.). These computer program products are means for providing software to computer system 1800.

Computer programs (also called computer control logic, programming logic, or logic) are stored in main memory 1806 and/or secondary memory 1820. Computer programs may also be received via communication interface 1840. Such computer programs, when executed, enable the computer system 1800 to implement features of the present invention as discussed herein. Accordingly, such computer programs represent controllers of the computer system 1800. Where the invention is implemented using software, the software may be stored in a computer program product and loaded into computer system 1800 using removable storage drive 1824, interface 1826, or communication interface 1840.

The invention is also directed to computer program products comprising software stored on any computer readable medium. Such software, when executed in one or more data processing devices, causes a data processing device(s) to operate as described herein. Embodiments of the present invention employ any computer readable medium, known now or in the future. Examples of computer readable mediums include, but are not limited to, primary storage devices (e.g., any type of random access memory) and secondary storage devices (e.g., hard drives, floppy disks, CD ROMS, zip disks, tapes, magnetic storage devices, optical storage devices, MEMs, nanotechnology-based storage device, etc.).

### V. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A computer-implemented method for incentivizing performance of an activity or observance of a behavior by a user, comprising:
presenting an offer to a user via a user device, wherein the terms of the offer comprise at least one activity to be performed by the user or at least one behavior to be observed by the user and at least one incentive to be rewarded to the user responsive to the performance of the at least one activity or the observance of the at least one behavior;
obtaining spatial, temporal, social and/or topical data associated with the user from a network-based tracking engine;
determining if the user has performed the at least one activity or observed the at least one behavior based on at least the obtained spatial, temporal, social and/or topical data; and
providing the user with the at least one incentive responsive to a determination that the user has performed the at least one activity or observed the at least one behavior.

2. The method of claim 1, further comprising:
receiving input from the user indicating that the user has elected to participate in the offer.

3. The method of claim 1, wherein determining if the user has performed the at least one activity or observed the at least one behavior comprises:
determining if the user has performed the at least one activity or observed the at least one behavior at a predetermined location based on the spatial data associated with the user.

4. The method of claim 1, wherein determining if the user has performed the at least one activity or observed the at least one behavior comprises:
determining if the user has performed the at least one activity or observed the at least one behavior at a predetermined time, within a predetermined time frame or at a predetermined temporal frequency based on the temporal data associated with the user.

5. The method of claim 1, wherein determining if the user has performed the at least one activity or observed the at least one behavior comprises:
determining if the user has performed the at least one activity in association with one or more social relations of the user based on the social data associated with the user.

6. The method of claim 1, wherein determining if the user has performed the at least one activity or observed the at least one behavior comprises:
determining if the user has performed at least one activity involving a predetermined object based on the topical data associated with the user.

7. The method of claim 1, wherein determining if the user has performed the at least one activity or observed the at least one behavior comprises:
determining if the user is co-located with one or more other persons based on the spatial and temporal data associated with the user.

8. The method of claim 1, further comprising:
obtaining user authentication information from the user;
wherein determining if the user has performed the at least one activity or observed the at least one behavior comprises determining if the user has performed the at least one activity or observed the at least one behavior based on the obtained user authentication information and the obtained spatial, temporal, social and/or topical data.

9. A system, comprising:
a user interface configured to present an offer to a user via a user device, wherein the terms of the offer comprise at least one activity to be performed by the user or at least one behavior to be observed by the user and at least one incentive to be rewarded to the user responsive to the performance of the at least one activity or the observance of the at least one behavior;
a condition tracking engine configured to obtain spatial, temporal, social and/or topical data from a network-based tracking engine and to determine if the user has performed the at least one activity or observed the at least one behavior based on at least the obtained spatial, temporal, social and/or topical data; and
a redemption engine configured to provide the user with the at least one incentive responsive to a determination that the user has performed the at least one activity or observed the at least one behavior.

10. The system of claim 9 wherein the user interface is further configured to receive input from the user indicating that the user has elected to participate in the offer.

11. The system of claim 9, wherein the condition tracking manager is configured to determine if the user has performed the at least one activity or observed the at least one behavior at a predetermined location based on spatial data associated with the user or a location.

12. The system of claim 9, wherein the condition tracking manager is configured to determine if the user has performed the at least one activity or observed the at least one behavior at a predetermined time, within a predetermined time frame or at a predetermined temporal frequency based on temporal data associated with the user, an activity or behavior.

13. The system of claim 9, wherein the condition tracking manager is configured to determine if the user has performed the at least one activity in association with one or more social relations of the user based on the social data.

14. The system of claim 9, wherein the condition tracking manager is configured to determine if the user has performed at least one activity involving a predetermined object based on topical data associated with the user or object.

15. The system of claim 9, wherein the condition tracking manager is configured to determine if the user is co-located with one or more other persons or a location based on the spatial and temporal data.

16. The system of claim 9, wherein the user interface is further configured to obtain user authentication information from the user and wherein the condition tracking manager is configured to determine if the user has performed the at least one activity or observed the at least one behavior based on the obtained user authentication information and the obtained spatial, temporal, social and/or topical data.

17. The system of claim 9, further comprising:
an incentive matching manager configured to select the offer for presentation to the user from among a plurality of offers.

18. A computer-implemented method for facilitating creation of a conditional incentive offer for presentation to a user, comprising:
presenting a plurality of conditions that may be associated with an incentive, wherein fulfillment of each of the plurality of conditions by a user may be determined by at least obtaining spatial, temporal, social and/or topical data associated with the user from a network-based tracking engine;
receiving input indicative of a selection of one or more of the plurality of conditions;
associating the selected condition(s) with a specified incentive; and
storing the selected condition(s) in association with the specified incentive for subsequent presentation to a user as terms of a conditional incentive offer.

19. The method of claim 17, further comprising:
receiving targeting criteria associated with the conditional incentive offer; and
selecting the conditional incentive offer for presentation to a user based on the targeting criteria.

20. The method of claim 17, further comprising:
receiving preference information from a user; and
selecting the conditional incentive offer for presentation to the user based on the preference information.
